(19) United States
(12) Patent Application Publication
(10) Pub. No.: US 2025/0113390 A1
(43) Pub. Date: Apr. 3, 2025

(54) FACTORS, BITRATES, OR PATH FOR MULTI-ACCESS PROTOCOL DATA UNIT SESSION WITH REDUNDANT STEERING MODE

(71) Applicant: QUALCOMM INCORPORATED, San Diego, CA (US)

(72) Inventors: Dario Serafino TONESI, San Diego, CA (US); Waqar ZIA, Munich (DE); Haris ZISIMOPOULOS, London (GB); Sunghoon KIM, San Diego, CA (US)

(21) Appl. No.: 18/728,673

(22) PCT Filed: Dec. 16, 2022
(86) PCT No.: PCT/US2022/081815

§ 371 Date: Jul. 12, 2024

(30) Foreign Application Priority Data
Mar. 28, 2022 (GR) 20220100267

(51) Int. Cl. H04W 76/10; H04L 47/24; H04W 28/02

(52) U.S. Cl. CPC H04W 76/10; H04L 47/24; H04W 28/0268

(57) ABSTRACT

Various aspects of the present disclosure generally relate to wireless communication. In some aspects, a network entity may receive policy and charging control (PCC) rules that indicate that a multi-access (MA) protocol data unit (PDU) session is to be established with a redundant steering mode. The network entity may transmit N4 interface rules that indicate the redundant steering mode and parameters for the MA PDU session, such as an uplink duplication factor, a downlink duplication factor, an uplink redundant bitrate, a downlink redundant bitrate, or an access path to duplicate. The network entity may transmit access traffic steering, switching, and splitting (ATSSS) rules that indicate, for the MA PDU session, an indication to use the redundant steering mode and the parameters. Numerous other aspects are described.

### CROSS-REFERENCE TO RELATED APPLICATION

This Patent Application claims priority to Greek Patent Application No. 20220100267, filed on Mar. 28, 2022, entitled “FACTORS, BITRATES, OR PATH FOR MULTI-ACCESS PROTOCOL DATA UNIT SESSION WITH REDUNDANT STEERING MODE,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for indicating parameters for a multi-access protocol data unit session used with a redundant steering mode.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a network entity (e.g., a session management function (SMF)). The method may include receiving policy and charging control (PCC) rules that indicate that a multi-access (MA) protocol data unit (PDU) session is to be established with a redundant steering mode. The method may include transmitting N4 interface rules that indicate, for the MA PDU session, one or more of an indication to use the redundant steering mode, an uplink duplication factor, a downlink duplication factor, an uplink redundant bitrate, a downlink redundant bitrate, or an access path to duplicate. The method may include transmitting access traffic steering, switching, and splitting (ATSSS) rules that indicate, for the MA PDU session, an indication to use the redundant steering mode, the one or more of the uplink duplication factor, the downlink duplication factor, the uplink redundant bitrate, the downlink redundant bitrate, or the access path.

Some aspects described herein relate to a method of wireless communication performed by a network entity (e.g., a policy control function). The method may include generating PCC rules that indicate that an MA PDU session with a redundant steering mode is to be established based at least in part on one or more requirements associated with an application. The method may include transmitting the PCC rules.

Some aspects described herein relate to a method of wireless communication performed by a user equipment (UE). The method may include receiving an indication that a quality of service (QoS) of QoS flows of a single access (SA) PDU session can be improved if an MA PDU session with a redundant steering mode is established. The method may include transmitting a request to convert the SA PDU session into the MA PDU session.

Some aspects described herein relate to a method of wireless communication performed by a network entity (e.g., an SMF). The method may include transmitting an indication that a QoS of QoS flows of an SA PDU session can be improved if an MA PDU session with a redundant steering mode is established. The method may include receiving a request to convert the SA PDU session into the MA PDU session. The method may include establishing the MA PDU session.

Some aspects described herein relate to a network entity for wireless communication. The network entity may include a memory and one or more processors coupled to the memory. The one or more processors may be configured to receive PCC rules that indicate that an MA PDU session is to be established with a redundant steering mode. The one or more processors may be configured to transmit N4 interface rules that indicate, for the MA PDU session, one or more of an indication to use the redundant steering mode, an uplink duplication factor, a downlink duplication factor, an uplink redundant bitrate, a downlink redundant bitrate, or an access path to duplicate. The one or more processors may be configured to transmit ATSSS rules that indicate, for the MA PDU session, an indication to use the redundant steering mode, the one or more of the uplink duplication factor, the downlink duplication factor, the uplink redundant bitrate, the downlink redundant bitrate, or the access path.

Some aspects described herein relate to a network entity for wireless communication. The network entity may include a memory and one or more processors coupled to the memory. The one or more processors may be configured to generate PCC rules that indicate that an MA PDU session with a redundant steering mode is to be established based at least in part on one or more requirements associated with an application. The one or more processors may be configured to transmit the PCC rules.

Some aspects described herein relate to a UE for wireless communication. The UE may include a memory and one or more processors coupled to the memory. The one or more processors may be configured to receive an indication that a QoS of QoS flows of an SA PDU session can be improved if an MA PDU session with a redundant steering mode is established. The one or more processors may be configured to transmit a request to convert the SA PDU session into the MA PDU session.

Some aspects described herein relate to a network entity for wireless communication. The network entity may include a memory and one or more processors coupled to the memory. The one or more processors may be configured to transmit an indication that a QoS of QoS flows of an SA PDU session can be improved if an MA PDU session with a redundant steering mode is established. The one or more processors may be configured to receive a request to convert the SA PDU session into the MA PDU session. The one or more processors may be configured to establish the MA PDU session.

Some aspects described herein relate to a non-transitory computer-readable medium that stores a set of instructions for wireless communication by a network entity. The set of instructions, when executed by one or more processors of the network entity, may cause the network entity to receive PCC rules that indicate that an MA PDU session is to be established with a redundant steering mode. The set of instructions, when executed by one or more processors of the network entity, may cause the network entity to transmit N4 interface rules that indicate, for the MA PDU session, one or more of an indication to use the redundant steering mode, an uplink duplication factor, a downlink duplication factor, an uplink redundant bitrate, a downlink redundant bitrate, or an access path to duplicate. The set of instructions, when executed by one or more processors of the network entity, may cause the network entity to transmit ATSSS rules that indicate, for the MA PDU session, an indication to use the redundant steering mode, the one or more of the uplink duplication factor, the downlink duplication factor, the uplink redundant bitrate, the downlink redundant bitrate, or the access path.

Some aspects described herein relate to a non-transitory computer-readable medium that stores a set of instructions for wireless communication by a network entity. The set of instructions, when executed by one or more processors of the network entity, may cause the network entity to generate PCC rules that indicate that an MA PDU session with a redundant steering mode is to be established based at least in part on one or more requirements associated with an application. The set of instructions, when executed by one or more processors of the network entity, may cause the network entity to transmit the PCC rules.

Some aspects described herein relate to a non-transitory computer-readable medium that stores a set of instructions for wireless communication by a UE. The set of instructions, when executed by one or more processors of the UE, may cause the UE to receive an indication that a QoS of QoS flows of an SA PDU session can be improved if an MA PDU session with a redundant steering mode is established. The set of instructions, when executed by one or more processors of the UE, may cause the UE to transmit a request to convert the SA PDU session into an MA PDU session.

Some aspects described herein relate to a non-transitory computer-readable medium that stores a set of instructions for wireless communication by a network entity. The set of instructions, when executed by one or more processors of the network entity, may cause the network entity to transmit an indication that a QoS of QoS flows of an SA PDU session can be improved if an MA PDU session with a redundant steering mode is established. The set of instructions, when executed by one or more processors of the network entity, may cause the network entity to receive a request to convert the SA PDU session into the MA PDU session. The set of instructions, when executed by one or more processors of the network entity, may cause the network entity to establish the MA PDU session.

Some aspects described herein relate to an apparatus for wireless communication. The apparatus may include means for receiving PCC rules that indicate that an MA PDU session is to be established with a redundant steering mode. The apparatus may include means for transmitting N4 interface rules that indicate, for the MA PDU session, one or more of an indication to use the redundant steering mode, an uplink duplication factor, a downlink duplication factor, an uplink redundant bitrate, a downlink redundant bitrate, or an access path to duplicate. The apparatus may include means for transmitting ATSSS rules that indicate, for the MA PDU session, an indication to use the redundant steering mode, the one or more of the uplink duplication factor, the downlink duplication factor, the uplink redundant bitrate, the downlink redundant bitrate, or the access path.

Some aspects described herein relate to an apparatus for wireless communication. The apparatus may include means for generating PCC rules that indicate that an MA PDU session with a redundant steering mode is to be established based at least in part on one or more requirements associated with an application. The apparatus may include means for transmitting the PCC rules.

Some aspects described herein relate to an apparatus for wireless communication. The apparatus may include means for receiving an indication that a QoS of QoS flows of an SA PDU session can be improved if an MA PDU session with a redundant steering mode is established. The apparatus may include means for transmitting a request to convert the SA PDU session into the MA PDU session.

Some aspects described herein relate to an apparatus for wireless communication. The apparatus may include means for transmitting an indication that a QoS of QoS flows of an SA PDU session can be improved if an MA PDU session with a redundant steering mode is established. The apparatus may include means for receiving a request to convert the SA PDU session into the MA PDU session. The apparatus may include means for establishing the MA PDU session.

Aspects generally include a method, apparatus, system, computer program product, non-transitory computer-readable medium, UE, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity in communication with a user equipment (UE) in a wireless network, in accordance with the present disclosure.

FIG. 3 is a diagram illustrating an example of a disaggregated base station, in accordance with the present disclosure.

FIG. 4 is a diagram of an example of a core network configured to provide network slicing, in accordance with the present disclosure.

FIG. 5 is a diagram illustrating an example of rule propagation, in accordance with the present disclosure.

FIG. 6 is a diagram illustrating an example of a redundant steering mode, in accordance with the present disclosure.

FIG. 7 is a diagram illustrating an example of a triggered service request, in accordance with the present disclosure.

FIGS. 8A-8B include a diagram illustrating an example of multi-access (MA) protocol data unit (PDU) session establishment, in accordance with the present disclosure.

FIG. 9 is a diagram illustrating an example associated with MA PDU session establishment, in accordance with the present disclosure.

FIG. 10 is a diagram illustrating another example associated with MA PDU session establishment, in accordance with the present disclosure.

FIG. 11 is a diagram illustrating an example process performed, for example, by a network entity, in accordance with the present disclosure.

FIG. 12 is a diagram illustrating an example process performed, for example, by a network entity, in accordance with the present disclosure.

FIG. 13 is a diagram illustrating an example process performed, for example, by a UE, in accordance with the present disclosure.

FIG. 14 is a diagram illustrating an example process performed, for example, by a network entity, in accordance with the present disclosure

FIGS. 15-17 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

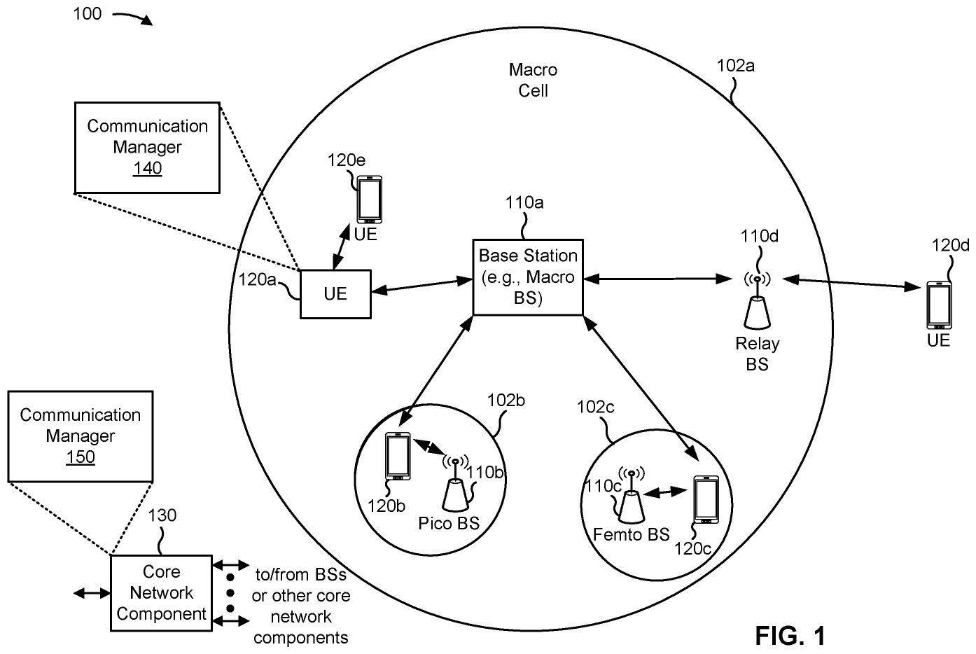

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the terms “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the terms “base station” or “network entity” may refer to one device configured to perform one or more functions, such as those described herein in connection with the base station 110. In some aspects, the terms “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the terms “base station” or “network entity” may refer to any one or more of those different devices. In some aspects, the terms “base station” or “network entity” may refer to one or more virtual base stations and/or one or more virtual base station functions. For example, in some aspects, two or more base station functions may be instantiated on a single device. In some aspects, the terms “base station” or “network entity” may refer to one of the base station functions and not another. In this way, a single device may include more than one base station. A network entity may also include a core network component

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BSs, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A core network component 130 may couple to or communicate with a set network entities or core network components. The core network component 130 may communicate with the base stations 110 via a backhaul communication link. The core network component 130 may communicate with other core network components directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed with other non-3GPP or non-cellular RATs (wide local area network, Wi-Fi). In some examples, UE 120 may communicate over a 3GPP access path or a non-3GPP access path.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a network entity (e.g., a core network component 130) may include a communication manager 150. As described in more detail elsewhere herein, the communication manager 150 may receive policy and charging control (PCC) rules that indicate that a multi-access (MA) protocol data unit (PDU) session is to be established with a redundant steering mode. The communication manager 150 may transmit N4 interface rules that indicate, for the MA PDU session, one or more of an indication to use the redundant steering mode, an uplink duplication factor, a downlink duplication factor, an uplink redundant bitrate, a downlink redundant bitrate, or an access path to duplicate. The communication manager 150 may transmit access traffic steering, switching, and splitting (ATSSS) rules that indicate, for the MA PDU session, an indication to use the redundant steering mode, the one or more of the uplink duplication factor, the downlink duplication factor, the uplink redundant bitrate, the downlink redundant bitrate, or the access path.

In some aspects, the network entity may include a communication manager 150. As described in more detail elsewhere herein, the communication manager 150 may transmit an indication that a quality of service (QoS) of QoS flows of an SA PDU session can be improved if an MA PDU session with a redundant steering mode is established. The communication manager 150 may receive a request to convert the SA PDU session into the MA PDU session; and establish the MA PDU session.

In some aspects, another network entity (e.g., a core network component 130) may include a communication manager 150. As described in more detail elsewhere herein, the communication manager 150 may generate PCC rules that indicate that an MA PDU session with a redundant steering mode is to be established based at least in part on one or more requirements associated with an application, and transmit the PCC rules. Additionally, or alternatively, the communication manager 150 may perform one or more other operations described herein.

In some aspects, a UE (e.g., a UE 120) may include a communication manager 140. As described in more detail elsewhere herein, the communication manager 140 may receive an indication that a QoS of QoS flows of a single access (SA) PDU session can be improved if an MA PDU session with a redundant steering mode is established. The communication manager 140 may transmit a request to convert the SA PDU session into the MA PDU session. Additionally, or alternatively, the communication manager 140 may perform one or more other operations described herein.

As indicated above, FIG. 1 is provided as an example. Other examples may differ from what is described with regard to FIG. 1.

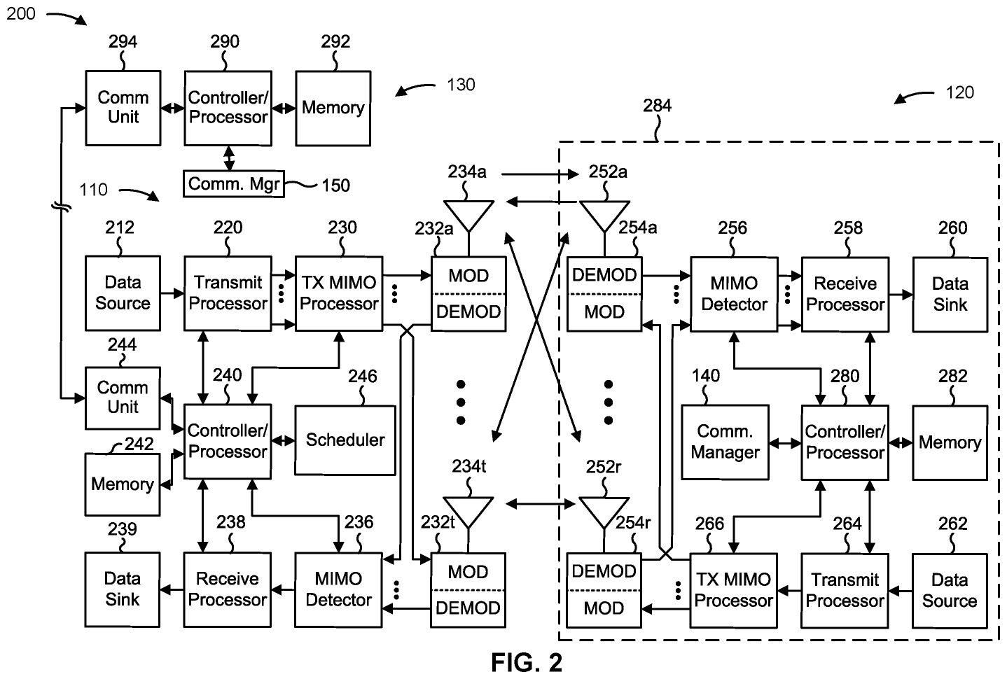

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The core network component 130 may include a communication unit 294, a controller/processor 290, and a memory 292. The core network component 130 may include, for example, one or more devices in a core network. The core network component 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

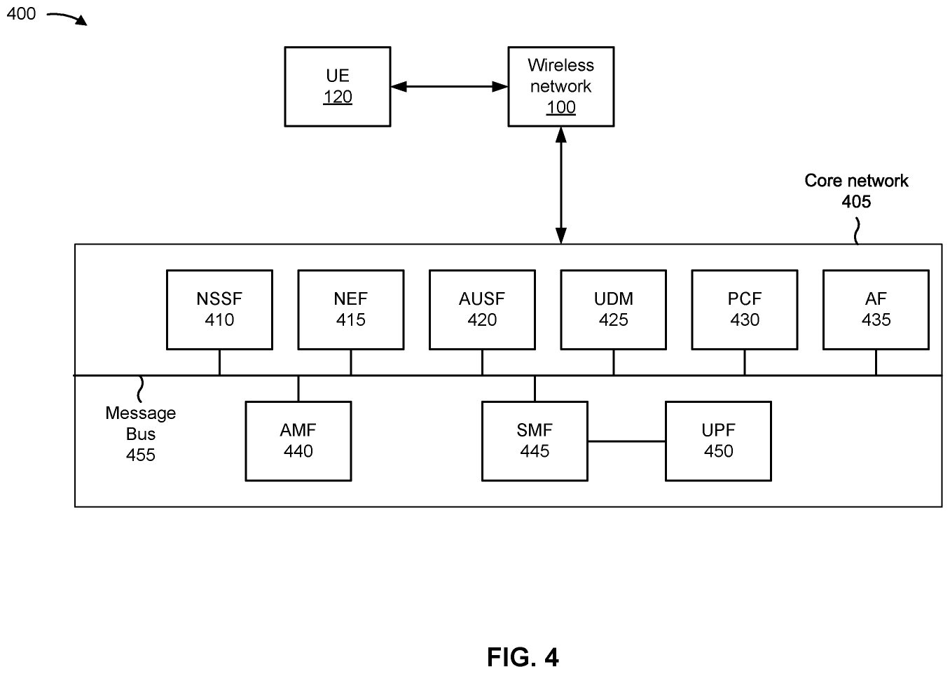

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-17).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with core network component 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-17).

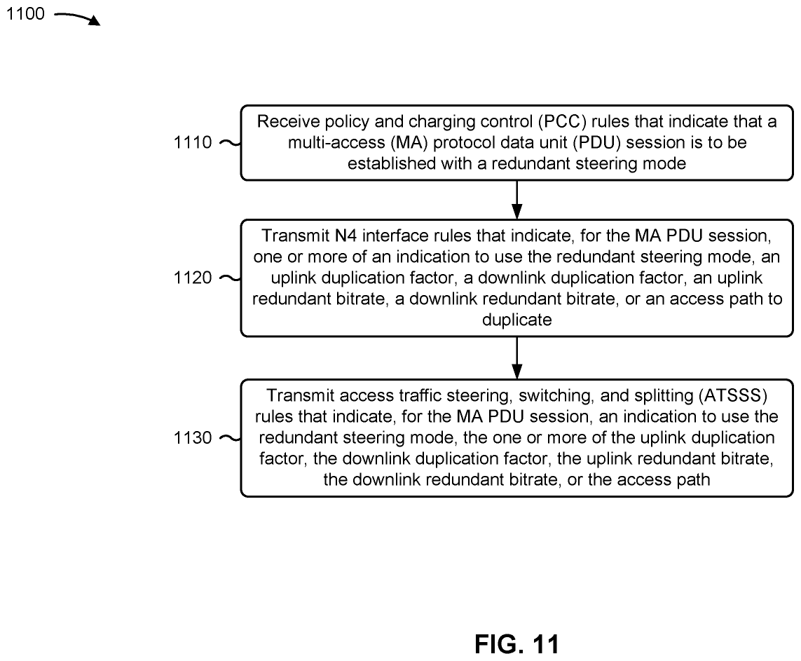

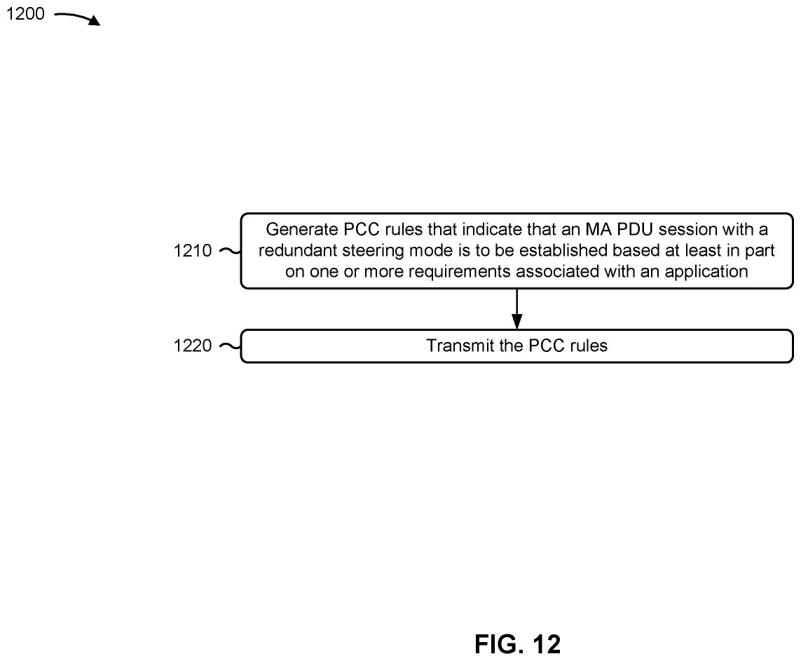

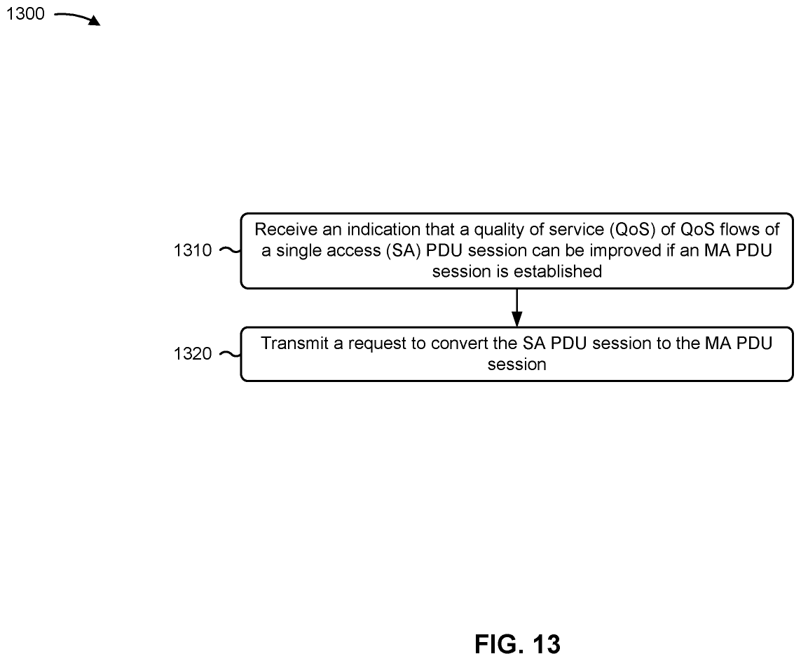

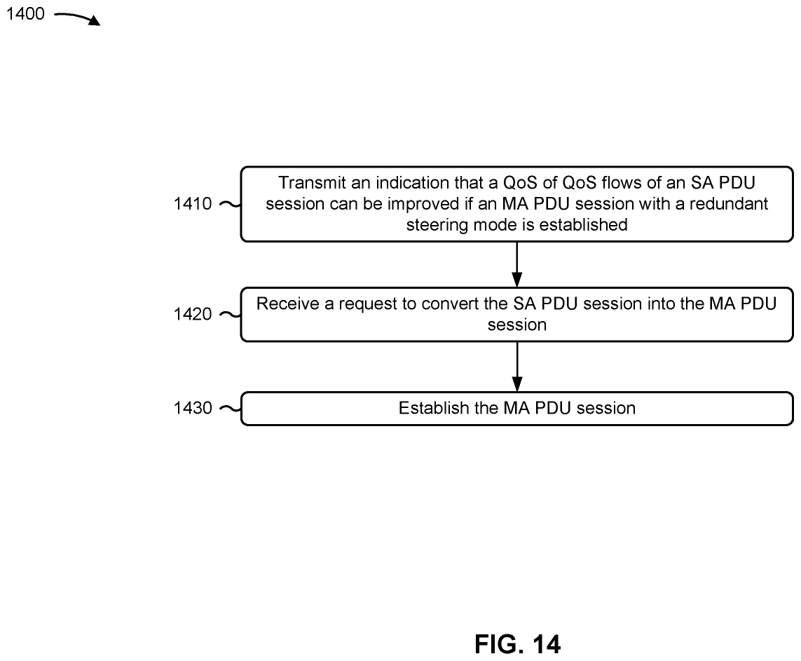

A controller/processor of a network entity (e.g., the controller/processor 290 of the core network component 130), the controller/processor 280 of the UE 120, and/or any other component(s) of FIG. 2 may perform one or more techniques associated with indicating parameters (e.g., duplication factor, redundant bitrate, access path) for an MA PDU session, as described in more detail elsewhere herein. For example, the controller/processor 290 of the core network component 130, the controller/processor 280 of the UE 120, and/or any other component(s) of FIG. 2 may perform or direct operations of, for example, process 1100 of FIG. 11, process 1200 of FIG. 12, process 1300 of FIG. 13, process 1400 of FIG. 14, and/or other processes as described herein. The memory 292 and the memory 282 may store data and program codes for the network entity and the UE 120, respectively. In some examples, the memory 292 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 1100 of FIG. 11, process 1200 of FIG. 12, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, a network entity (e.g., a core network component 130) includes means for receiving PCC rules that indicate that an MA PDU session is to be established with a redundant steering mode; means for transmitting N4 interface rules that indicate, for the MA PDU session, one or more of an indication to use the redundant steering mode, an uplink duplication factor, a downlink duplication factor, an uplink redundant bitrate, a downlink redundant bitrate, or an access path to duplicate; and/or means for transmitting ATSSS rules that indicate, for the MA PDU session, an indication to use the redundant steering mode, the one or more of the uplink duplication factor, the downlink duplication factor, the uplink redundant bitrate, the downlink redundant bitrate, or the access path. In some aspects, the means for the network entity to perform operations described herein may include, for example, one or more of communication manager 150, communication unit 294, a controller/processor 290, or memory 292.

In some aspects, the network entity includes means for transmitting an indication that a QoS of QoS flows of an SA PDU session can be improved if an MA PDU session with a redundant steering mode is established; means for receiving a request to convert the SA PDU session into the MA PDU session; and/or means for establishing the MA PDU session.

In some aspects, another network entity (e.g., a core network component) includes means for generating PCC rules that indicate that an MA PDU session with a redundant steering mode is to be established based at least in part on one or more requirements associated with an application; and/or means for transmitting the PCC rules. In some aspects, the means for the other network entity to perform operations described herein may include, for example, one or more of communication manager 150, communication unit 294, a controller/processor 290, or memory 292.

In some aspects, a UE (e.g., a UE 120) includes means for receiving an indication that a QoS of QoS flows of an SA PDU session can be improved if an MA PDU session with a redundant steering mode is established; and/or means for transmitting a request to convert the SA PDU session into an MA PDU session. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

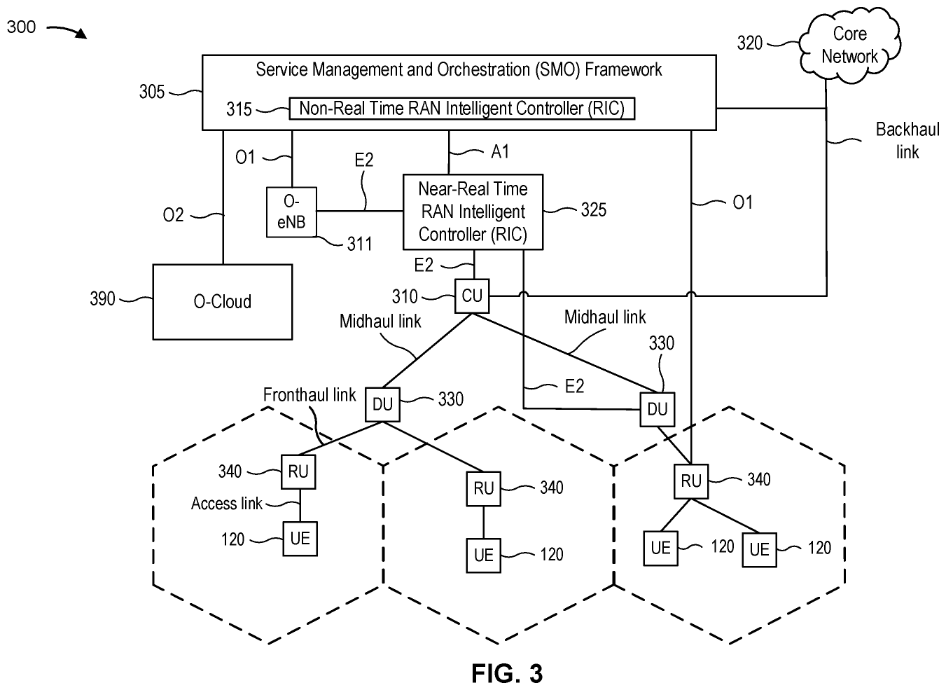

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network entity, a network element, or a network equipment, such as a base station, or one or more units (or one or more components) performing base station functionality, may be implemented in an aggregated or disaggregated architecture. For example, a BS (such as a Node B, evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more RF access links. In some aspects, the UE 120 may be simultaneously served by multiple RUs 340. The DUs 330 and the RUs 340 may also be referred to as “O-RAN DUs (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

FIG. 4 is a diagram of an example 400 of a core network 405 configured to provide network slicing, in accordance with the present disclosure. As shown in FIG. 4, example 400 may include a UE 120, a wireless communication network 100, and a core network 405. Devices (e.g., core network entities) and/or networks of example 400 may interconnect via wired connections, wireless connections, or a combination thereof.

The UE 120 may include one or more devices capable of receiving, generating, storing, processing, and/or providing information, such as information described herein. For example, the UE 120 may include a mobile phone (e.g., a smart phone or a radiotelephone, among other examples), a laptop computer, a tablet computer, a desktop computer, a handheld computer, a gaming device, a wearable communication device (e.g., a smart watch or a pair of smart glasses, among other examples), a mobile hotspot device, a fixed wireless access device, customer premises equipment, an autonomous vehicle, or a similar type of device.

The wireless communication network 100 may support, for example, a cellular RAT. The network 100 may include one or more network entities, such as base stations (e.g., base transceiver stations, radio base stations, node Bs, eNBs, gNBs, base station subsystems, cellular sites, cellular towers, access points, TRPs, radio access nodes, macrocell base stations, microcell base stations, picocell base stations, femtocell base stations, or similar types of devices) and other network entities that can support wireless communication for the UE 120. The network 100 may transfer traffic between the UE 120 (e.g., using a 3GPP or cellular RAT) on a 3GPP access path, one or more base stations (e.g., using a wireless interface or a backhaul interface, such as a wired backhaul interface), and/or the core network 405. The network 100 may provide one or more cells that cover geographic areas. In some aspects, the network 100 may transfer traffic between the UE 120, one or more base stations, and/or the core network 405 using a non-3GPP or non-cellular RAT on a non-3GPP access path.

In some aspects, the network 100 may perform scheduling and/or resource management for the UE 120 covered by the network 100 (e.g., the UE 120 covered by a cell provided by the network 100). In some aspects, the network 100 may be controlled or coordinated by a network controller, which may perform load balancing and/or network-level configuration, among other examples. As described above in connection with FIG. 1, the network controller may communicate with the network 100 via a wireless or wireline backhaul. In some aspects, the network 100 may include a network controller, a self-organizing network (SON) module or component, or a similar module or component. Accordingly, the network 100 may perform network control, scheduling, and/or network management functions (e.g., for uplink, downlink, and/or sidelink communications of the UE 120 covered by the network 100).

In some aspects, the core network 405 may include an example functional architecture in which systems and/or methods described herein may be implemented. For example, the core network 405 may include an example architecture of a 5G core (5GC) network included in a 5G wireless telecommunications system. Although the example architecture of the core network 405 shown in FIG. 4 may be an example of a service-based architecture, in some aspects, the core network 405 may be implemented as a reference-point architecture and/or a 4G core network, among other examples.

As shown in FIG. 4, the core network 405 may include a number of functional elements in devices (e.g., network entities). The functional elements may include, for example, a network slice selection function (NSSF) 410, a network exposure function (NEF) 415, an authentication server function (AUSF) 420, a unified data management (UDM) component 425, a policy control function (PCF) 430, an application function (AF) 435, an access and mobility management function (AMF) 440, a session management function (SMF) 445, and/or a user plane function (UPF) 450, among other examples. These functional elements may be communicatively connected via a message bus 455. Each of the functional elements shown in FIG. 4 may be implemented on one or more devices associated with a wireless telecommunications system. In some implementations, one or more of the functional elements may be implemented on physical devices, such as an access point, a base station, and/or a gateway, among other examples. In some implementations, one or more of the functional elements may be implemented on a computing device of a cloud computing environment.

The NSSF 410 may include one or more devices that select network slice instances for the UE 120. Network slicing is a network architecture model in which logically distinct network slices operate using common network infrastructure. For example, several network slices may operate as isolated end-to-end networks customized to satisfy different target service standards for different types of applications executed, at least in part, by the UE 120 and/or communications to and from the UE 120. Network slicing may efficiently provide communications for different types of services with different service standards.

The NSSF 410 may determine a set of network slice policies to be applied at the network 100. For example, the NSSF 410 may apply one or more UE route selection policy (URSP) rules. In some aspects, the NSSF 410 may select a network slice based on a mapping of a data network name (DNN) field included in a route selection description (RSD) to the DNN field included in a traffic descriptor selected by the UE 120. By providing network slicing, the NSSF 410 allows an operator to deploy multiple substantially independent end-to-end networks potentially with the same infrastructure. In some implementations, each slice may be customized for different services.

The NEF 415 may include one or more devices that support exposure of capabilities and/or events in the wireless telecommunications system to help other entities in the wireless telecommunications system discover network services. The AUSF 420 may include one or more devices that act as an authentication server and support the process of authenticating the UE 120 in the wireless telecommunications system.

The UDM 425 may include one or more devices that store user data and profiles in the wireless telecommunications system. In some aspects, the UDM 425 may be used for fixed access and/or mobile access, among other examples, in the core network 405.

The PCF 430 may include one or more devices that provide a policy framework that incorporates network slicing, roaming, packet processing, and/or mobility management, among other examples. In some aspects, the PCF 430 may include one or more URSP rules used by the NSSF 410 to select network slice instances for the UE 120.

The AF 435 may include one or more devices that support application influence on traffic routing, access to the NEF 415, and/or policy control, among other examples. The AMF 440 may include one or more devices that act as a termination point for non-access stratum (NAS) signaling and/or mobility management, among other examples. In some aspects, the AMF may request the NSSF 410 to select network slice instances for the UE 120, e.g., at least partially in response to a request for data service from the UE 120.

The SMF 445 may include one or more devices that support the establishment, modification, and release of communication sessions in the wireless telecommunications system. For example, the SMF 445 may configure traffic steering policies at the UPF 450 and/or enforce UE IP address allocation and policies, among other examples. In some aspects, the SMF 445 may provision the network slice instances selected by the NSSF 410 for the UE 120.

The UPF 450 may include one or more devices that serve as an anchor point for intra-RAT and/or inter-RAT mobility. In some aspects, the UPF 450 may apply rules to packets, such as rules pertaining to packet routing, traffic reporting, and/or handling user plane QoS, among other examples.

The message bus 455 may be a logical and/or physical communication structure for communication among the functional elements. Accordingly, the message bus 455 may permit communication between two or more functional elements, whether logically (e.g., using one or more application programming interfaces (APIs), among other examples) and/or physically (e.g., using one or more wired and/or wireless connections).

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of example 400 may perform one or more functions described as being performed by another set of devices of example environment 400.

A UE may steer traffic according to one of several ATSSS steering modes. In an active-standby mode, the UE steers a service data flow (SDF) or QoS flow by using the active access if the active access is available. If the active access is not available and the standby access is available, the UE steers the SDF by using the standby access. In a smallest delay mode, the UE steers the SDF by using the access network with the smallest round-trip time. If there is only one access available, the UE steers the SDF by using the available access. This steering mode is only applicable to non-guaranteed bit rate (non-GBR) SDF. In a load balancing mode, the UE steers the SDF across both the 3GPP access and the non-3GPP access with a given percentage if both accesses are available. If there is only one access available, the UE steers the SDF by using the available access. This steering mode is only applicable to non-GBR SDF. In a priority-based mode, the UE steers the SDF over the access with high priority unless the access with high priority is congested or unavailable, when the UE steers the SDF over both the access with high priority and the access with low priority. This steering mode is only applicable to non-GBR SDF.

As indicated above, FIG. 4 is provided as an example. Other examples may differ from what is described with regard to FIG. 4.

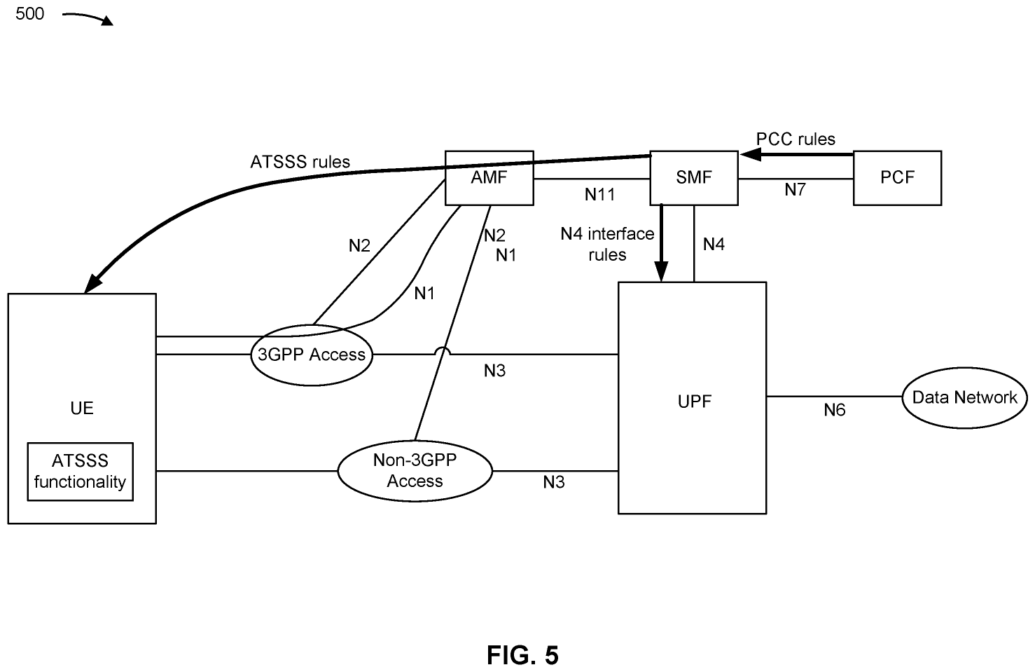

FIG. 5 is a diagram illustrating an example 500 of rule propagation, in accordance with the present disclosure. Example 500 shows that an AMF may communicate with a UE over an N1 interface and control access paths with signaling over an N2 interface. A UPF may communicate with the UE over an N3 interface. An SMF may communicate with the UPF over an N4 interface. The UPF may communicate with a data network over an N6 interface. A PCF may transmit information to the SMF over an N7 interface. The signaling between the AMF and the SMF may be carried on an N11 interface.

Example 500 shows that a PCF may provide PCC rules to the SMF, which in turn provides ATSSS rules to the UE and N4 interface rules to the UPF. The PCF may transmit the PCC rules over the N7 interface. The SMF may transmit rules to the UE via the AMF. For example, the SMF may transmit the ATSSS rules to the AMF over the N11 interface, and the AMF may then transmit the ATSSS rules to the UE over the N1 interface. The SMF may transmit the N4 interface rules over the N4 interface.

As indicated above, FIG. 5 is provided as an example. Other examples may differ from what is described with regard to FIG. 5.

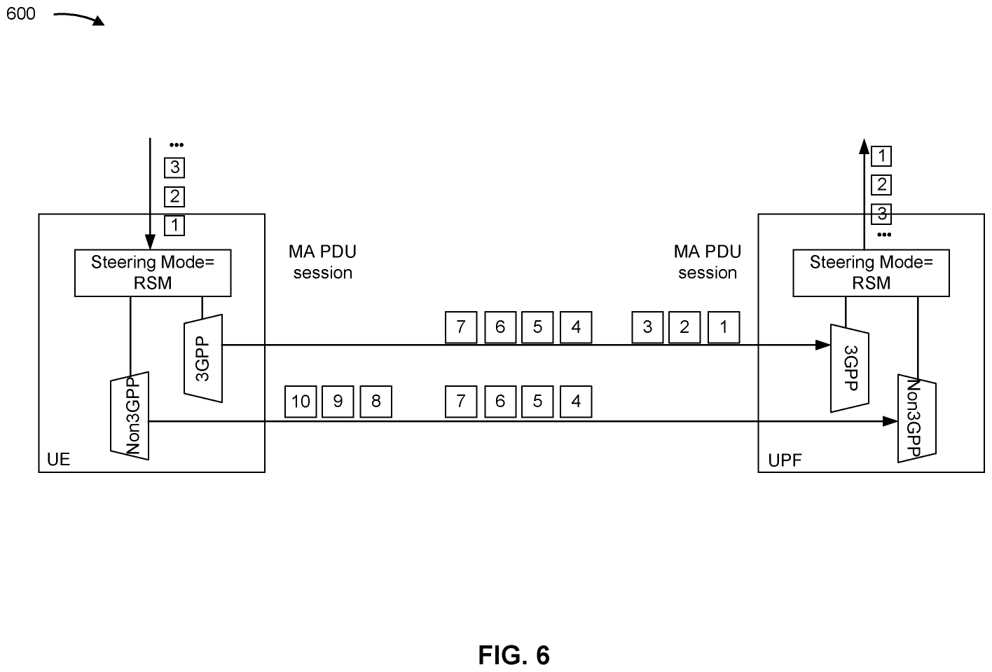

FIG. 6 is a diagram illustrating an example 600 of a redundant steering mode, in accordance with the present disclosure.

In some aspects, a UE (e.g., UE 120) may use a redundant steering mode (RSM) that allows duplication of traffic (over another access path) of some or all of the PDUs exchanged between the UE and a UPF. Example 600 shows that representative PDUs 1-10 are exchanged between the UE and the UPF in an MA PDU session, where PDUs 1-7 are transmitted on a 3GPP access path and PDUs 4-10 are transmitted on a non-3GPP access path. However, in the MA PDU session, PDUs 4-7 are duplicated on both the 3GPP access path and the non-3GPP access path.

In some aspects, to support the RSM, the PCF may indicate, to the SMF, that an MA PDU session is to be used. The PCF may include parameters in PCC rules, such as an uplink maximum bitrate authorized for an SDF (e.g., QoS flow) and/or a downlink maximum bitrate authorized for the SDF. The PCC rules may also include parameters such as an uplink GBR authorized for the SDF and/or a downlink GBR authorized for the SDF. The SMF may translate and/or propagate the parameters to the UE via ATSSS rules and to the UPF via N4 interface rules.

For GBR QOS flows, if the RSM enables the (partial or full) duplication of PDUs over two different access paths, the data transfer rate (e.g., bitrate) required by the application (and managed by the AF) may be different from the actual, combined bitrate reserved by the network. For example, if the AF requests that the PCF transfer data with a GBR of 1 megabits per second (Mbps), but the 5G core network instructs the UE (with ATSSS rules) and the UPF (with N4 interface rules) to use up to 50% duplication of PDUs for the RSM, the bitrate experienced by the UE and by the UPF on the combined access paths may be up to 1.5 Mbps. The inconsistency between the 1 Mbps GBR and the combined bitrate of up to 1.5 Mbps can lead to network planning issues and/or a lack of signaling resources because the 5G network would need to allocate and use more signaling resources than requested by the AF.

According to various aspects described herein, the 5G network may indicate the RSM (for an MA PDU session) in PCC rules from the PCF to the SMF, ATSSS rules from the SMF to the UE, and/or N4 interface rules from the SMF to the UPF. The SMF may also indicate (encode) in the ATSSS rules and the N4 interface rules, MA PDU session parameters, such as an uplink and/or a downlink duplication factor (e.g., percentage) for a duplicated path. The parameters may also include uplink and/or downlink redundant bitrates (e.g., 100%-200% of the regular bitrate). Redundant bitrates may include maximum bitrates or GBRs. In some aspects, the PCF may provide the parameters in the PCC rules if the PCF is to control the amount of duplication (e.g., based on a packet error rate (PER) required by the AF). In some aspects, the parameters may indicate a secondary access path over which duplication takes place. The indicated access paths may be 3GPP-access paths or non-3GGP access paths. For example, if the duplication factor is 50%, and the secondary access path is a non-3GPP access path, 100% of the traffic flows over the 3GPP access path and up to 50% of the traffic is duplicated over the non-3GPP access path.

The AF, the PCF, or the SMF may determine the access paths that are to be duplicated and indicate such parameters in the respective rules. The RSM may be transparent to the AF.

As indicated above, FIG. 6 is provided as an example. Other examples may differ from what is described with regard to FIG. 6.

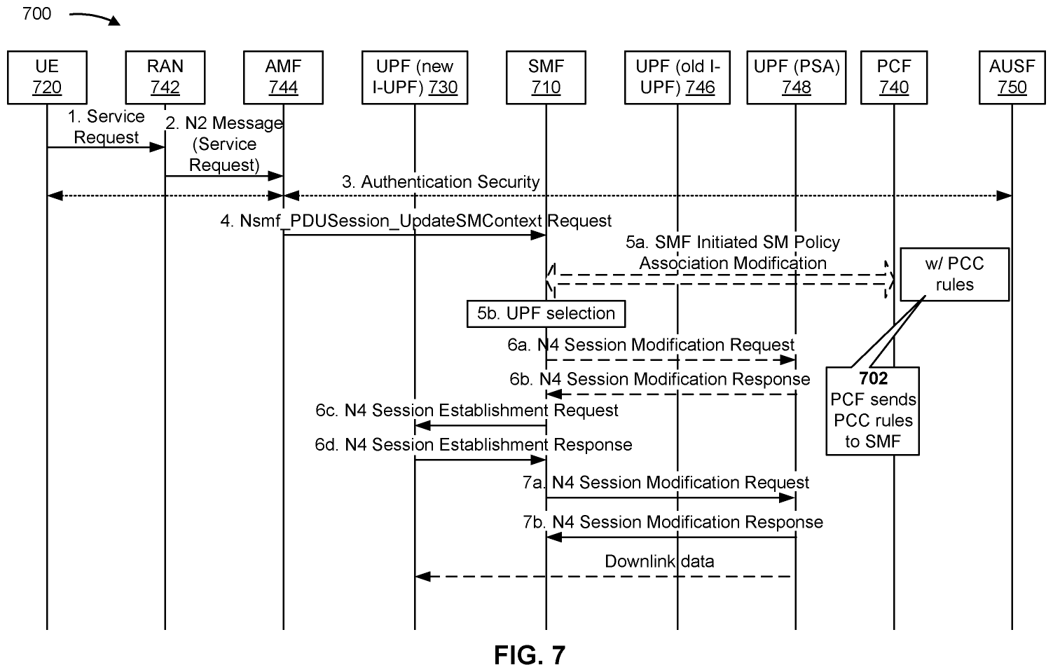

FIG. 7 is a diagram illustrating an example 700 of a triggered service request, in accordance with the present disclosure. Example 700 shows a core network entity, such as a SMF 710 (e.g., SMF 445) of a core network (e.g., core network 405), that controls an MA PDU session with a UE 720 (e.g., a UE 120) and a UPF 730 (e.g., UPF 450).

The SMF 710 may receive PCC rules and/or an indication of the RSM with a MA PDU session from a PCF 740 (e.g., PCF 430). There may also be a radio access network (RAN) 742, an AMF 744, an old UPF 746, a PDU session anchor (PSA) UPF 748, and an AUSF 750 (e.g., AUSF 420), among other core network entities.

There may be multiple steps in a UE-triggered service request, as shown in example 700. For example, the UE 720 may transit a service request (Step 1), which is forwarded to the AMF 744 (Step 2). After authentication security (Step 3), the AMF 744 transmits a PDU session update context request (Step 4). As shown by reference number 702, the PCF 740 may transmit the PCC rules as part of policy modification signaling (Step 5a), followed by UPF selection (Step 5b). The SMF 710 may perform an N4 session modification with the PSA UPF 748 (Steps 6a-6b), N4 session establishment with the UPF 730 (Steps 6c-6d), and N4 session modification (Steps 7a-7b).

As indicated above, FIG. 7 is provided as an example. Other examples may differ from what is described with regard to FIG. 7.

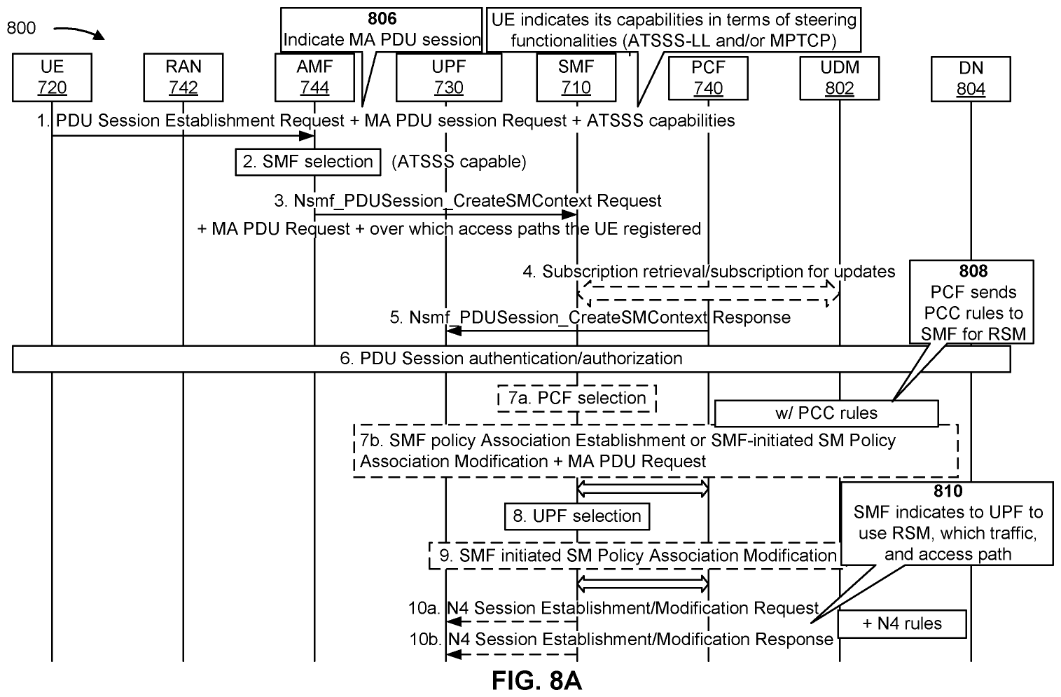

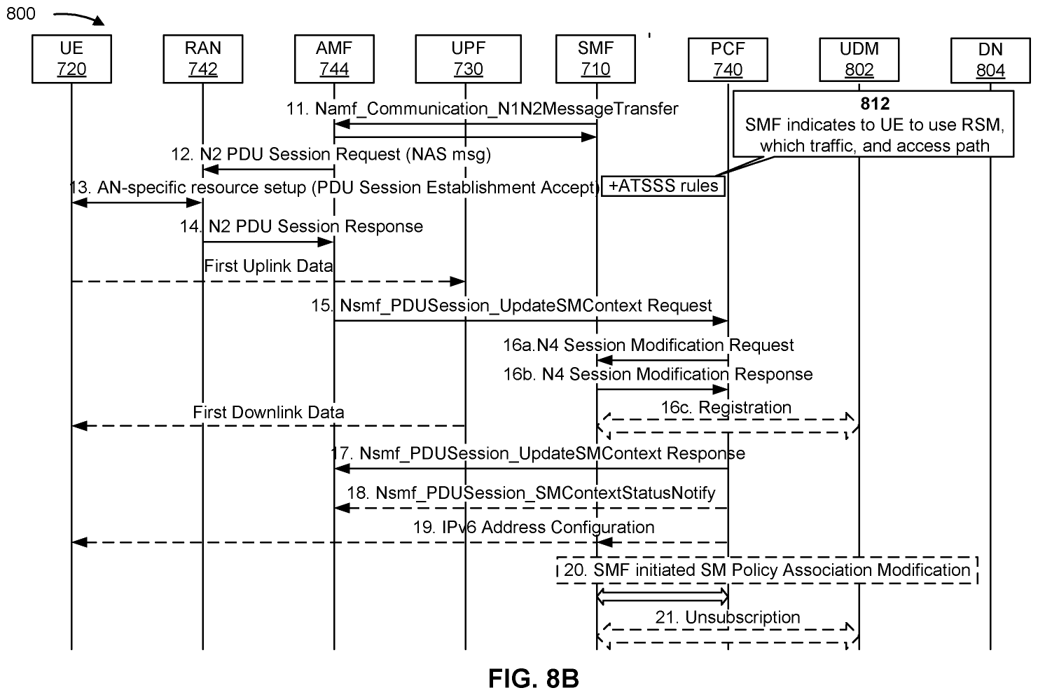

FIGS. 8A-8B include diagrams illustrating an example 800 of MA PDU session establishment, in accordance with the present disclosure. Example 800 in FIGS. 8A-8B includes components shown in example 700 with the addition of a UDM 802 (e.g., UDM 425) and a data network (DN) 804.

Example 800 shows multiple steps of establishing an MA PDU session. As shown in FIG. 8A, the UE 720 may transmit a PDU session establishment request (Step 1). As shown by reference number 806, the request may be for an MA PDU session. In some aspects, the request may include steering functionalities, such as ATSSS capabilities (at a lower layer (LL) such as Layer 2) and/or multipath transmission control protocol (MPTCP) capabilities for supporting the MA PDU session. The capabilities may include capabilities for parameters such as an uplink maximum bitrate, a downlink maximum bitrate, an uplink GBR, and/or a downlink GBR. After SMF selection (Step 2) of the SMF 710, which may be expected to be ATSSS capable, the AMF 744 may transmit a PDU session create context request to the SMF 710 (Step 3). In some aspects, this may include an MA PDU session request associated with accesses that are registered with the UE 720. The SMF 710 may retrieve or update subscription information with the UDM 802 (Step 4). The SMF 710 may transmit a response to the AMF 744 (Step 5). Step 6 involves PDU session authentication and authorization.

The SMF 710 may perform PCF selection (Step 7a) and policy association establishment or modification (Step 7b). In some aspects, the SMF 710 may indicate the MA PDU session request to the PCF 740. As shown by reference number 808, the SMF 710 may receive the PCC rules from the PCF 740, indicating the RSM. The process continues with UPF selection (Step 8), policy association modification (Step 9), and N4 session establishment or modification (Steps 10a-10b).

The SMF 710 may indicate steering functionality and a steering mode to the UPF 730. As shown by reference number 810, the SMF 710 may indicate to the UPF 730, in N4 interface rules, to use the RSM, which traffic to duplicate, and/or the access path for which the duplication is to take place. The N4 interface rules may include a duplication factor and/or redundant bitrate parameters, such as the uplink maximum bitrate, the downlink maximum bitrate, the uplink GBR, and/or the downlink GBR. The N4 interface rules may be based at least in part on the ATSSS capabilities of the UE 720 and/or the PCC rules received from the PCF 740.

FIG. 8B shows a continuation of the MA PDU session establishment with an AMF message transfer (Step 11), which may indicate that the MA PDU session is accepted. Steps 12-14 show MA PDU session establishment. The SMF 710 may transmit the ATSSS rules to the UE 720. As shown by reference number 812, the SMF 710 may indicate, in the ATSSS rules, the RSM to the UE 720 and what traffic (which access path) is to be duplicated and/or over which access path the duplication is to take place. The ATSSS rules may include the duplication factor and/or the redundant bitrate parameters received from the PCF 740 or determined at the SMF 710.

Steps 15-16c show PDU session and N4 session updates and registration. Steps 17-19 show SMF PDU session updates and an internet protocol (IP) address configuration. Steps 20-21 show SMF policy modification between the SMF 710 and the PCF 740 and unsubscription.

As indicated above, FIGS. 8A-8B are provided as an example. Other examples may differ from what is described with regard to FIGS. 8A-8B.

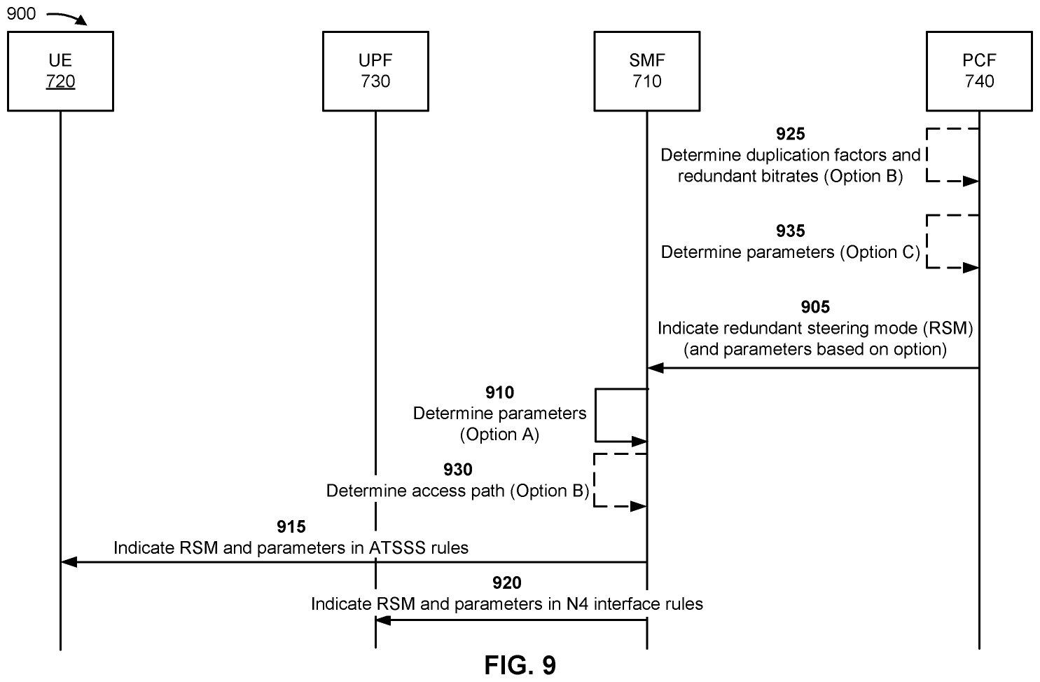

FIG. 9 is a diagram illustrating an example 900 associated with MA PDU session establishment, in accordance with the present disclosure. Example 900 shows options for the signaling between the SMF 710, the UE 720, the UPF 730, and the PCF 740 that are specific to the MA PDU session.

There are several options as to how the MA PDU session may be indicated and how the parameters may be controlled. In some aspects, in a first option (Option A), the PCF 740 may decide that the RSM is needed, based on data transfer requirements from the AF. As shown by reference number 905, the PCF 740 may transmit PCC rules that indicate the RSM. For Option A, as shown by reference number 910, the SMF 710 may determine the MA PDU session parameters (e.g., duplication factors, redundant bitrates, access path to duplicate) based on, for example, the PCC rules. The SMF 710 may indicate the RSM with the parameters in the ATSSS rules, as shown by reference number 915, and in the N4 interface rules, as shown by reference number 920. In the first option, there may be minimal changes to the PCC rules logic as the SMF 710 determines the parameters. In some aspects, the RSM may be indicated and applied per direction (uplink or downlink) independently.

In some aspects, the SMF 710 may encode a duplication factor in the ATSSS rules similarly to the load balancing factor (10%, 20%, . . . , 100%). For example, the SMF 710 may reuse the weight parameter that is already used for the load balancing factor.

In some aspects, the access path may be indicated separately from the other parameters. The ATSSS rules may indicate the RSM in an octet of a steering mode descriptor field that is encoded for RSM (e.g., 00000101). Another octet may be used to indicate parameters such as duplication factor percentages, and yet another octet may be used to indicate the secondary access path. For example, a first octet value in a first octet may indicate a 10% duplication factor over the secondary access path. A second octet value in the same first octet may indicate a 20% duplication factor over the secondary access path. A third octet value in the first octet may indicate a 90% duplication factor over the secondary access path. A fourth octet value in the first octet may indicate a 100% duplication factor over the secondary access path. Other percentages may be used. A first value in a second octet may indicate a non-3GPP access path. A second value in the second octet may indicate a 3GPP access path.

Alternatively, the SMF 710 may encode parameters, such as the duplication factor, in the ATSSS rules with the access path indication. That is, the same octet may indicate the duplication factor and the secondary access path. For example, a first octet value may indicate a 10% duplication factor over a non-3GPP access path. A second octet value in the same octet may indicate a 20% duplication factor over the non-3GPP access path. A third octet value may indicate a 90% duplication factor over the non-3GPP access path. A fourth octet value may indicate a 100% duplication factor over the non-3GPP access path. A fifth octet value may indicate a 10% duplication factor over a 3GPP access path. A sixth octet value may indicate a 20% duplication factor over the 3GPP access path. A seventh octet value may indicate a 90% duplication factor over the 3GPP access path. An eighth octet value may indicate a 100% duplication factor over the 3GPP access path.

In some aspects, in a second option (Option B), the PCF 740 may determine the duplication factors and/or the redundant bit rates but not which access paths to duplicate, as shown by reference number 925. The PCF 740 may determine the duplication factors and/or the redundant bit rates based at least in part on, for example, data transfer requirements from the AF. Accordingly, the SMF 710 may determine the access paths to be duplicated, as shown by reference number 930.

In some aspects, in a third option (Option C), the PCF 740 may determine all of the MA PDU session parameters, as shown by reference number 935. This may involve more changes to the PCC rules logic, and the SMF 710 may simply translate the parameters received in the PCC rules logic into parameters in the ATSSS rules and the N4 interface rules.

By establishing an MA PDU session with RSM, the 5GC network may improve communication on access paths using existing signaling. The UE 710 and the 5GC may make efficient use of signaling resources.

As indicated above, FIG. 9 is provided as an example. Other examples may differ from what is described with respect to FIG. 9.

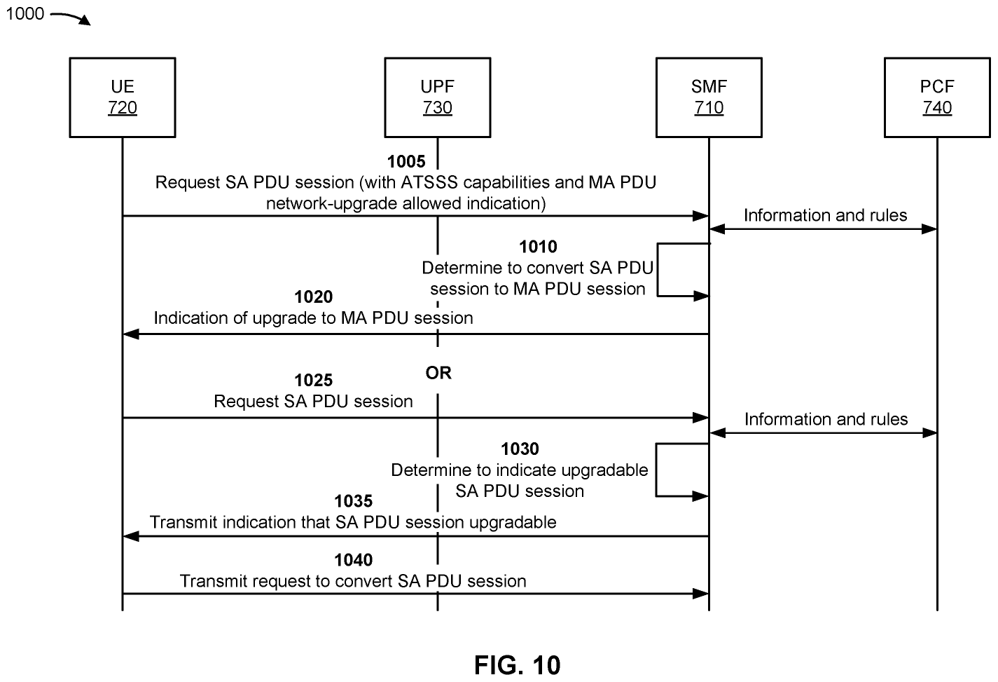

FIG. 10 is a diagram illustrating another example 1000 associated with MA PDU session establishment, in accordance with the present disclosure. Example 1000 shows a signaling between the SMF 710, the UE 720, the UPF 730, and the PCF 740.

There may be scenarios in which it is beneficial for the core network to trigger the establishment of an MA PDU session using the RSM. For example, if the AF asks the PCF to transfer data with a PER of 10-6, the PCF 740 or the SMF 710 may determine that the PER is not achievable with a single access path. The PCF 740 or the SMF 710 may trigger establishment of an MA PDU session or the modification of an SA PDU session into an MA PDU session. The PCF 740 and the SMF may indicate parameters for the MA PDU session.

Example 1000 shows an example of the SMF 710 converting an SA PDU session request into an MA PDU session. As shown by reference number 1005, the UE 720 may request an SA PDU session with ATSSS capabilities and/or an indication that an MA PDU network upgrade is allowed. With reference to Step 1 in FIG. 8A, the UE 720 may set a Request Type to initial request that includes an “MA PDU Network-Upgrade Allowed” indication in an uplink non-access stratum (NAS) transport message and ATSSS capabilities in a PDU session establishment request message, if the 5GC network is ATSSS capable, and no policy in the UE 720 (e.g. no URSP rule) and no local restrictions mandate an SA for the requested PDU Session. The “MA PDU Network-Upgrade Allowed” indication indicates that the requested SA PDU session may be converted to an MA PDU session, if the 5GC network so indicates.

If the upgrade allowed indication is received from UE 720, the SMF 710 may determine to convert the SA PDU session into an MA PDU session with the RSM, as shown by reference number 1010. As shown by reference number 1020, the SMF 710 may transmit an indication of an upgrade to a MA PDU session. With reference to Step 2 in FIG. 8A, if the AMF 744 receives the “MA PDU Network-Upgrade Allowed” indication, the AMF 744 may select an SMF that supports MA PDU sessions. The AMF 744 may not send the “MA PDU Request” indication to the SMF 710, but the AMF 744 may send the “MA PDU Network-Upgrade Allowed” indication, if received from the UE 720. If the AMF 744 determines that the request (e.g., single network slide selection assistance information (S-NSSAI)) is not allowed on both access paths, the AMF 744 may not forward the “MA PDU Network-Upgrade Allowed” indication to the SMF 710. If the AMF 744 transmits the “MA PDU Network-Upgrade Allowed” indication to the SMF 710, the AMF 744 may also indicate to the SMF 710 whether the UE 720 is registered over both access paths. If the PDU session establishment request is for a local area data network, the AMF 744 may not forward the “MA PDU Network-Upgrade Allowed” indication to the SMF 710.

With reference to Step 6 in FIG. 8A, if the SMF 710 receives the “MA PDU Network-Upgrade Allowed” indication, the SMF 710 may decide, if dynamic PCC is not to be used, to convert the SA PDU Session requested by the UE 720 into an MA PDU Session. The SMF 710 may determine, based at least in part on a local operator policy, subscription data indicating whether the MA PDU session is allowed or not, among other conditions. If the SMF 710 receives ATSSS capabilities from the UE 720 but does not receive the “MA PDU Network-Upgrade Allowed” indication from the AMF 744, the SMF 710 may not convert the SA PDU session requested by the UE 720 into an MA PDU session. If the SMF 710 receives a UP security policy for the PDU session with integrity protection set to “Required” and the MA PDU session is being established over a non-3GPP access path, the SMF 710 may not verify whether the access can satisfy the UP security policy.

With reference to Step 7 in FIG. 8A, if dynamic PCC rules are to be used for the PDU Session, the SMF 710 may indicate to the PCF 740 that the session management (SM) policy control information is requested for an MA PDU session via an “MA PDU Network-Upgrade Allowed” indication if the MA PDU session is allowed based on the subscription data. The SMF 710 may provide the currently used access types and RAT types for the MA-PDU session to the PCF 740 (e.g., home PCF (H-PCF)). The SMF 710 may also provide the ATSSS capabilities of the MA PDU session.

The SMF 710 may transmit an indication of the RSM and/or MA PDU session parameters in ATSSS rules and N4 interface rules as described in connection with FIG. 9. If the UE 720 is registered to both access paths, the UE 720 may consider that an MA PDU session is established for both access paths and begin to use the RSM. If the UE 720 is not registered to other access paths, the UE 720 may initiate a PDU session establishment request over the other access paths and then use the RSM. If not done previously, the SMF 740 may trigger the usage of the RSM by updating the ATSSS and N4 interface rules with a PDU session modification procedure. With reference to Step 10 of FIG. 8A, the N4 interface rules derived by the SMF 710 for the MA-PDU session are transmitted to the UPF 730, and two N3 interface uplink core network tunnels are allocated by the UPF 730.

With reference to Step 11 of FIG. 8B, for the MA PDU Session, the SMF 710 may transmit an “MA PDU session Accepted” indication in the Namf_Communication_NIN2MessageTransfer message to the AMF 744. The AMF 744 may mark this PDU session as being an MA PDU session based at least in part on the received “MA PDU session Accepted” indication. The PDU session establishment accept message may include the ATSSS rules, which indicate to the UE 720 that the requested PDU session was converted by the network to an MA PDU session. The SMF 710 may trigger the establishment of user-plane resources in both access paths, if it was indicated in Step 2 that the UE 720 is registered over both access paths.

Alternatively, the SMF 710 may allow the UE 720 to trigger conversion of an SA PDU session into an MA PDU session. As shown by reference number 1025, the UE 720 may transmit a request for an SA PDU session. The request may be without ATSSS capabilities. The request may indicate that an upgrade to an MA PDU session is allowable. As shown by reference number 1030, the SMF 710 may determine to indicate that the SA PDU session is upgradeable. The SMF 710 may establish the SA PDU session with a QoS that is downgraded from a QoS requested by the AF. The SMF 710 may transmit QoS information in SM signaling (e.g., quality indicator in PDU session establishment accept message). As shown by reference number 1035, the SMF 710 may transmit an indication that the downgraded QoS may be improved if the UE 720 requests an MA PDU session with RSM.

The UE 720 may determine to use the downgraded QoS. The traffic conditions may be acceptable for a period of time, but if the network coverage (e.g., Wi-Fi coverage on a non-3GPP access path) becomes unstable, the UE 720 may determine to upgrade the QoS, and the UE 720 may select a non-3GPP access path and trigger modification of the SA PDU session to an MA PDU session with RSM. As shown by reference number 1040, the UE 720 may also request the MA PDU session upon receiving the indication of a downgraded QoS. In some aspects, the UE 720 may transmit a request to convert the SA PDU session into an MA PDU session. This may include transmitting a request to modify the SA PDU session into a MA PDU session or transmitting a request to terminate the SA PDU session and establish a new MA PDU session.

By establishing an MA PDU session according to the aspects described in connection with FIG. 10, the UE 720 may have more control as to when to establish an MA PDU session using the RSM. This may be as soon as the UE 720 has both 3GPP access and non-3GPP access.

As indicated above, FIG. 10 is provided as an example. Other examples may differ from what is described with regard to FIG. 10.

FIG. 11 is a diagram illustrating an example process 1100 performed, for example, by a network entity, in accordance with the present disclosure. Example process 1100 is an example where the network entity (e.g., network entity 130, SMF 710) performs operations associated with indicating duplication factors, redundant bitrates, or access paths for MA PDU sessions with an RSM.

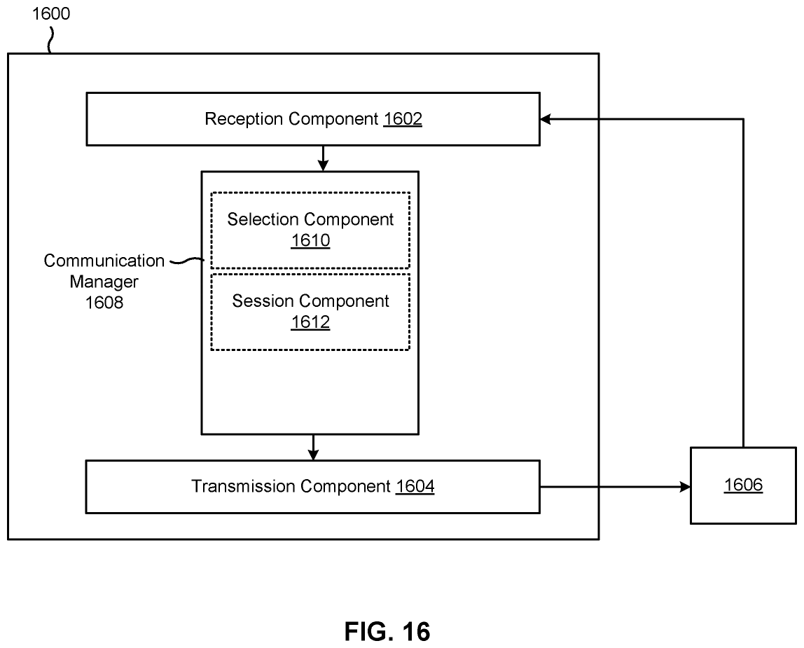

As shown in FIG. 11, in some aspects, process 1100 may include receiving PCC rules that indicate that an MA PDU session is to be established with a redundant steering mode (block 1110). For example, the network entity (e.g., using communication manager 1608 and/or reception component 1602 depicted in FIG. 16) may receive PCC rules that indicate that an MA PDU session is to be established with an RSM, as described above in connection with FIGS. 4-10.

As further shown in FIG. 11, in some aspects, process 1100 may include transmitting N4 interface rules that indicate, for the MA PDU session, one or more of an indication to use the RSM, an uplink duplication factor, a downlink duplication factor, an uplink redundant bitrate, a downlink redundant bitrate, or an access path to duplicate (block 1120). For example, the network entity (e.g., using communication manager 1608 and/or transmission component 1604 depicted in FIG. 16) may transmit N4 interface rules that indicate, for the MA PDU session, one or more of an indication to use the RSM, an uplink duplication factor, a downlink duplication factor, an uplink redundant bitrate, a downlink redundant bitrate, or an access path to duplicate, as described above in connection with FIGS. 4-10.

As further shown in FIG. 11, in some aspects, process 1100 may include transmitting ATSSS rules that indicate, for the MA PDU session, an indication to use the RSM, the one or more of the uplink duplication factor, the downlink duplication factor, the uplink redundant bitrate, the downlink redundant bitrate, or the access path to duplicate (block 1130). For example, the network entity (e.g., using communication manager 1608 and/or transmission component 1604 depicted in FIG. 16) may transmit ATSSS rules that indicate, for the MA PDU session, an indication to use the RSM, the one or more of the uplink duplication factor, the downlink duplication factor, the uplink redundant bitrate, the downlink redundant bitrate, or the access path to duplicate, as described above in connection with FIGS. 4-10.

Process 1100 may include additional aspects, such as any single aspect or any combination of aspects described below and/or in connection with one or more other processes described elsewhere herein.

In a first aspect, the network entity is an SMF.

In a second aspect, alone or in combination with the first aspect, process 1100 includes selecting the one or more of the uplink duplication factor, the downlink duplication factor, the uplink redundant bitrate, the downlink redundant bitrate, or the access path.

In a third aspect, alone or in combination with one or more of the first and second aspects, process 1100 includes receiving a message that indicates the one or more of the uplink duplication factor, the downlink duplication factor, the uplink redundant bitrate, or the downlink redundant bitrate.

In a fourth aspect, alone or in combination with one or more of the first through third aspects, receiving the message includes receiving PCC rules from a PCF.

In a fifth aspect, alone or in combination with one or more of the first through fourth aspects, process 1100 includes selecting the access path.

In a sixth aspect, alone or in combination with one or more of the first through fifth aspects, the message indicates the access path.

In a seventh aspect, alone or in combination with one or more of the first through sixth aspects, the ATSSS rules and the N4 interface rules indicate the redundant steering mode associated with the MA PDU session.

In an eighth aspect, alone or in combination with one or more of the first through seventh aspects, the ATSSS rules and the N4 interface rules indicate an amount of traffic of the access path.

In a ninth aspect, alone or in combination with one or more of the first through eighth aspects, the ATSSS rules and the N4 interface rules indicate the access path.

In a tenth aspect, alone or in combination with one or more of the first through ninth aspects, the ATSSS rules and the N4 interface rules indicate an amount of traffic to duplicate for one or more 3GPP access paths and one or more non-3GPP access paths.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network entity, in accordance with the present disclosure. Example process 1200 is an example where the network entity (e.g., core network entity 130, PCF 740) performs operations associated with indicating duplication factors, redundant bitrates, or access paths for MA PDU sessions with an RSM.

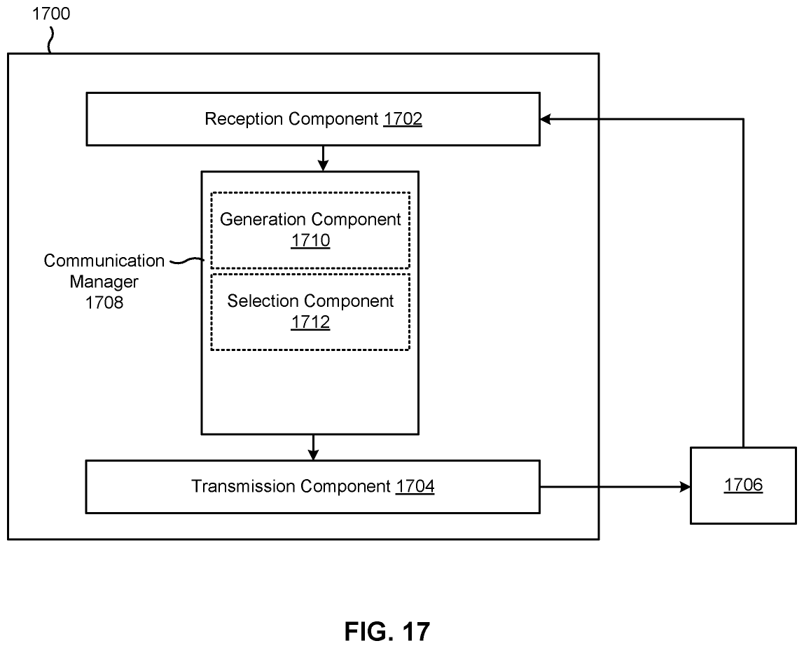

As shown in FIG. 12, in some aspects, process 1200 may include generating PCC rules that indicate that an MA PDU session with an RSM is to be established based at least in part on one or more requirements associated with an application (block 1210). For example, the network entity (e.g., using communication manager 1708 and/or generation component 1710 depicted in FIG. 17) may generate PCC rules that indicate that an MA PDU session with an RSM is to be established based at least in part on one or more requirements associated with an application, as described above in connection with FIGS. 4-10.

As further shown in FIG. 12, in some aspects, process 1200 may include transmitting the PCC rules (block 1220). For example, the network entity (e.g., using communication manager 1708 and/or transmission component 1704 depicted in FIG. 17) may transmit the PCC rules, as described above in connection with FIGS. 4-10.

Process 1200 may include additional aspects, such as any single aspect or any combination of aspects described below and/or in connection with one or more other processes described elsewhere herein.

In a first aspect, the network entity is a PCF.

In a second aspect, alone or in combination with the first aspect, process 1200 includes selecting one or more of an uplink duplication factor, a downlink duplication factor, an uplink redundant bitrate, or a downlink redundant bitrate for the MA PDU session, where the PCC rules indicate one or more of the uplink duplication factor, the downlink duplication factor, the uplink redundant bitrate, or the downlink redundant bitrate.

In a third aspect, alone or in combination with one or more of the first and second aspects, process 1200 includes selecting an access path to duplicate, where the PCC rules indicate the access path.

In a fourth aspect, alone or in combination with one or more of the first through third aspects, transmitting the PCC rules includes transmitting the PCC rules to an SMF.

In a fifth aspect, alone or in combination with one or more of the first through fourth aspects, process 1200 includes receiving the one or more requirements from an application function.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a UE, in accordance with the present disclosure. Example process 1300 is an example where the UE (e.g., UE 120) performs operations associated with using duplication factors, redundant bitrates, or access paths for MA PDU sessions with an RSM.

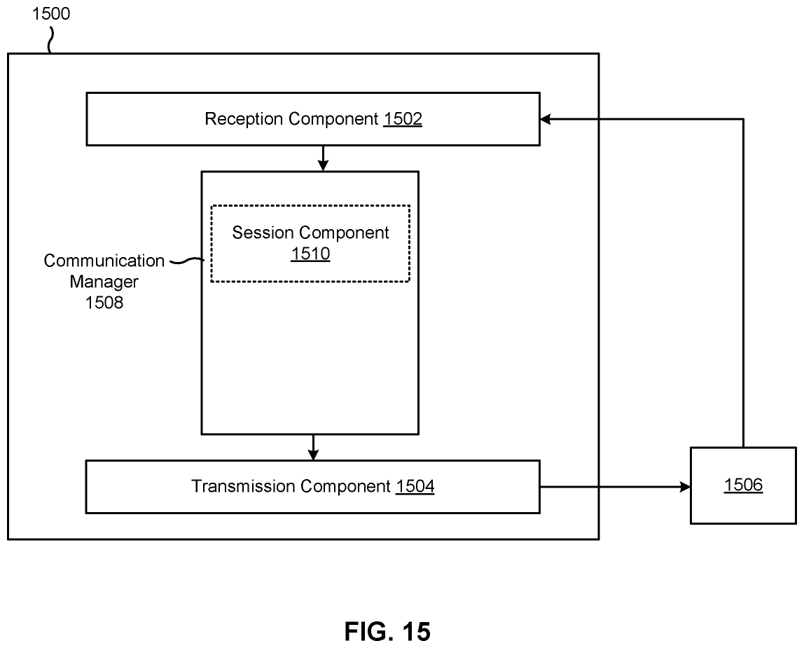

As shown in FIG. 13, in some aspects, process 1300 may include receiving an indication that a QoS of QoS flows of an SA PDU session can be improved if an MA PDU session with an RSM is established (block 1310). For example, the UE (e.g., using communication manager 1508 and/or reception component 1502 depicted in FIG. 15) may receive an indication that a QoS of QoS flows of an SA PDU session can be improved if an MA PDU session with an RSM is established, as described above in connection with FIGS. 4-10.

As further shown in FIG. 13, in some aspects, process 1300 may include transmitting a request to convert the SA PDU session into the MA PDU session (block 1320). For example, the UE (e.g., using communication manager 140 and/or transmission component 1504 depicted in FIG. 15) may transmit a request to convert the SA PDU session into the MA PDU session, as described above in connection with FIGS. 4-10. In some aspects, the request to convert the SA PDU session into the MA PDU session may be a request to modify the SA PDU session. In some aspects, the request to convert the SA PDU session into the MA PDU session may be a request to terminate the SA PDU session and create the MA PDU session.

Process 1300 may include additional aspects, such as any single aspect or any combination of aspects described below and/or in connection with one or more other processes described elsewhere herein.

In a first aspect, process 1300 includes receiving ATSSS rules that indicate, for the MA PDU session, one or more of an indication to use the RSM, an uplink duplication factor, a downlink duplication factor, an uplink redundant bitrate, a downlink redundant bitrate, or an access path to duplicate.

In a second aspect, alone or in combination with the first aspect, the ATSSS rules indicate an amount of traffic to duplicate for one or more 3GPP access paths and one or more non-3GPP access paths.

In a third aspect, alone or in combination with one or more of the first and second aspects, process 1300 includes communicating during the MA PDU session with at least one of the one or more of the uplink duplication factor, the downlink duplication factor, the uplink redundant bitrate, the downlink redundant bitrate, or the access path.

In a fourth aspect, alone or in combination with one or more of the first through third aspects, transmitting the request includes transmitting the request based at least in part on one or more of a data transfer requirement, a channel condition, traffic condition, or network coverage.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a network entity, in accordance with the present disclosure. Example process 1400 is an example where the network entity (e.g., core network entity 130, SMF 710) performs operations associated with indicating duplication factors, redundant bitrates, or access paths for MA PDU sessions with an RSM.

As shown in FIG. 14, in some aspects, process 1400 may include transmitting an indication that a QoS of QoS flows of an SA PDU session can be improved if an MA PDU session with an RSM is established (block 1410). For example, the network entity (e.g., using communication manager 1608 and/or transmission component 1604 depicted in FIG. 16) may transmit an indication that a QoS of QoS flows of an SA PDU session can be improved if an MA PDU session with an RSM is established, as described above in connection with FIGS. 4-10.

As further shown in FIG. 14, in some aspects, process 1400 may include receiving a request to convert the SA PDU session into the MA PDU session (block 1420). For example, the network entity (e.g., using communication manager 1608 and/or reception component 1602 depicted in FIG. 16) may receive a request to convert the SA PDU session into the MA PDU session, as described above in connection with FIGS. 4-10. In some aspects, the request to convert the SA PDU session into the MA PDU session may be a request to modify the SA PDU session. In some aspects, the request to convert the SA PDU session into the MA PDU session may be a request to terminate the SA PDU session and create the MA PDU session.

As further shown in FIG. 14, in some aspects, process 1400 may include establishing the MA PDU session (block 1430). For example, the network entity (e.g., using communication manager 1608 and/or session component 1612 depicted in FIG. 16) may establish the MA PDU session, as described above in connection with FIGS. 4-10. In some aspects, establishing the MA PDU session may include modifying the SA PDU session. In some aspects, establishing the MA PDU session may include terminating the SA PDU session and creating the MA PDU session.

Process 1400 may include additional aspects, such as any single aspect or any combination of aspects described below and/or in connection with one or more other processes described elsewhere herein.

In a first aspect, the network entity is an SMF.

In a second aspect, alone or in combination with the first aspect, process 1400 includes transmitting ATSSS rules and N4 interface rules that indicate, for the MA PDU session, one or more of an indication to use an RSM, an uplink duplication factor, a downlink duplication factor, an uplink redundant bitrate, a downlink redundant bitrate, or an access path to duplicate.

In a third aspect, alone or in combination with one or more of the first and second aspects, process 1400 includes receiving a data transfer requirement, where transmitting the indication includes transmitting the indication based at least in part on one or more of the data transfer requirement, a channel condition, or a traffic condition.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication. The apparatus 1500 may be a UE (e.g., a UE 120, UE 720), or a UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, a network entity, or another wireless communication device) using the reception component 1502 and the transmission component 1504. As further shown, the apparatus 1500 may include the communication manager 1508. The communication manager 1508 may control and/or otherwise manage one or more operations of the reception component 1502 and/or the transmission component 1504. In some aspects, the communication manager 1508 may include one or more antennas, a modem, a controller/processor, a memory, or a combination thereof, of the UE described in connection with FIG. 2. The communication manager 1508 may be, or be similar to, the communication manager 140 depicted in FIGS. 1 and 2. For example, in some aspects, the communication manager 1508 may be configured to perform one or more of the functions described as being performed by the communication manager 140. In some aspects, the communication manager 1508 may include the reception component 1502 and/or the transmission component 1504. The communication manager 1508 may include a session component 1510, among other examples.

In some aspects, the apparatus 1500 may be configured to perform one or more operations described herein in connection with FIGS. 1-10. Additionally, or alternatively, the apparatus 1500 may be configured to perform one or more processes described herein, such as process 1300 of FIG. 13, or a combination thereof. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

The reception component 1502 may receive an indication that a QoS of QoS flows of an SA PDU session can be improved if an MA PDU session with an RSM is established. The session component 1510 may determine whether to use an SA PDU session or an MA PDU session. The transmission component 1504 may transmit a request to convert the SA PDU session into an MA PDU session.

The reception component 1502 may receive ATSSS rules that indicate, for the MA PDU session, one or more of an indication to use the RSM, an uplink duplication factor, a downlink duplication factor, an uplink redundant bitrate, a downlink redundant bitrate, or an access path to duplicate.

The transmission component 1504 and the reception component 1502 may communicate during the MA PDU session with at least one of the one or more of the uplink duplication factor, the downlink duplication factor, the uplink redundant bitrate, the downlink redundant bitrate, or the access path.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication. The apparatus 1600 may be a network entity (e.g., SMF 710), or a network entity may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, a core network component, or another wireless communication device) using the reception component 1602 and the transmission component 1604. As further shown, the apparatus 1600 may include the communication manager 1608. The communication manager 1608 may control and/or otherwise manage one or more operations of the reception component 1602 and/or the transmission component 1604. In some aspects, the communication manager 1608 may include one or more antennas, a modem, a controller/processor, a memory, or a combination thereof, of the core network component described in connection with FIG. 2. The communication manager 1608 may be, or be similar to, the communication manager 150 depicted in FIGS. 1 and 2. For example, in some aspects, the communication manager 1608 may be configured to perform one or more of the functions described as being performed by the communication manager 150. In some aspects, the communication manager 1608 may include the reception component 1602 and/or the transmission component 1604. The communication manager 1608 may include a selection component 1610 and/or a session component 1612, among other examples.

In some aspects, the apparatus 1600 may be configured to perform one or more operations described herein in connection with FIGS. 1-10. Additionally, or alternatively, the apparatus 1600 may be configured to perform one or more processes described herein, such as process 1100 of FIG. 11, process 1400 of FIG. 14, or a combination thereof. In some aspects, the apparatus 1600 and/or one or more components shown in FIG. 16 may include one or more components of the network entity described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the network entity described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the network entity described in connection with FIG. 2. In some aspects, the transmission component 1604 may be co-located with the reception component 1602 in a transceiver.

The reception component 1602 may receive PCC rules that indicate that an MA PDU session is to be established with an RSM. The transmission component 1604 may transmit N4 interface rules that indicate, for the MA PDU session, one or more of an indication to use the RSM, an uplink duplication factor, a downlink duplication factor, an uplink redundant bitrate, a downlink redundant bitrate, or an access path to duplicate. The transmission component 1704 may transmit ATSSS rules that indicate, for the MA PDU session, an indication to use the redundant steering mode, the one or more of the uplink duplication factor, the downlink duplication factor, the uplink redundant bitrate, the downlink redundant bitrate, or the access path to duplicate.

The selection component 1610 may select the one or more of the uplink duplication factor, the downlink duplication factor, the uplink redundant bitrate, the downlink redundant bitrate, or the access path. The reception component 1602 may receive a message that indicates the one or more of the uplink duplication factor, the downlink duplication factor, the uplink redundant bitrate, or the downlink redundant bitrate. The selection component 1610 may select the access path.

In some aspects, the transmission component 1604 may transmit an indication that a QoS of QoS flows of an SA PDU session can be improved if an MA PDU session with an RSM is established. The reception component 1602 may receive a request to convert the SA PDU session into the MA PDU session. The session component 1612 may establish the MA PDU session.

The transmission component 1604 may transmit ATSSS rules and N4 interface rules that indicate, for the MA PDU session, one or more of an indication to use an RSM, an uplink duplication factor, a downlink duplication factor, an uplink redundant bitrate, a downlink redundant bitrate, or an access path to duplicate.

The reception component 1602 may receive a data transfer requirement, where transmitting the indication includes transmitting the indication based at least in part on one or more of the data transfer requirement, a channel condition, or a traffic condition.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of an example apparatus 1700 for wireless communication. The apparatus 1700 may be a network entity (e.g., PCF 740), or a network entity may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, a base station, a core network component, or another wireless communication device) using the reception component 1702 and the transmission component 1704. As further shown, the apparatus 1700 may include the communication manager 1708. The communication manager 1708 may include a generation component 1710 and/or a selection component 1712, among other examples.

In some aspects, the apparatus 1700 may be configured to perform one or more operations described herein in connection with FIGS. 1-10. Additionally, or alternatively, the apparatus 1700 may be configured to perform one or more processes described herein, such as process 1200 of FIG. 12, or a combination thereof. In some aspects, the apparatus 1700 and/or one or more components shown in FIG. 17 may include one or more components of the network entity described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the network entity described in connection with FIG. 2.

The transmission component 1704 may transmit communications, such as reference signals, control information, data communications, or a combination thereof, to the apparatus 1706. In some aspects, one or more other components of the apparatus 1700 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the network entity described in connection with FIG. 2. In some aspects, the transmission component 1704 may be co-located with the reception component 1702 in a transceiver.

The generation component 1710 may generate PCC rules that indicate that an MA PDU session with an RSM is to be established based at least in part on one or more requirements associated with an application. The transmission component 1704 may transmit the PCC rules.

The selection component 1712 may select one or more of an uplink duplication factor, a downlink duplication factor, an uplink redundant bitrate, or a downlink redundant bitrate for the MA PDU session, where the PCC rules indicate one or more of the uplink duplication factor, the downlink duplication factor, the uplink redundant bitrate, or the downlink redundant bitrate. The selection component 1712 may select an access path to duplicate, where the PCC rules indicate the access path. The reception component 1702 may receive the one or more requirements from an AF.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

The following provides an overview of some Aspects of the present disclosure:

Aspect 1: A method of wireless communication performed by a network entity, comprising: receiving policy and charging control (PCC) rules that indicate that a multi-access (MA) protocol data unit (PDU) session is to be established with a redundant steering mode; transmitting N4 interface rules that indicate, for the MA PDU session, one or more of an indication to use the redundant steering mode, an uplink duplication factor, a downlink duplication factor, an uplink redundant bitrate, a downlink redundant bitrate, or an access path to duplicate; and transmitting access traffic steering, switching, and splitting (ATSSS) rules that indicate, for the MA PDU session, an indication to use the redundant steering mode, the one or more of the uplink duplication factor, the downlink duplication factor, the uplink redundant bitrate, the downlink redundant bitrate, or the access path.

Aspect 2: The method of Aspect 1, wherein the network entity is a session management function.

Aspect 3: The method of Aspect 1 or 2, further comprising selecting the one or more of the uplink duplication factor, the downlink duplication factor, the uplink redundant bitrate, the downlink redundant bitrate, or the access path.

Aspect 4: The method of any of Aspects 1-3, further comprising receiving a message that indicates the one or more of the uplink duplication factor, the downlink duplication factor, the uplink redundant bitrate, or the downlink redundant bitrate.

Aspect 5: The method of Aspect 4, wherein receiving the message includes receiving PCC rules from a policy and control function.

Aspect 6: The method of Aspect 4 or 5, further comprising selecting the access path.

Aspect 7: The method of Aspect 4 or 5, wherein the message indicates the access path.

Aspect 8: The method of any of Aspects 1-7, wherein the ATSSS rules and the N4 interface rules indicate the redundant steering mode associated with the MA PDU session.

Aspect 9: The method of any of Aspects 1-8, wherein the ATSSS rules and the N4 interface rules indicate an amount of traffic of the access path.

Aspect 10: The method of any of Aspects 1-9, wherein the ATSSS rules and the N4 interface rules indicate the access path.

Aspect 11: The method of any of Aspects 1-10, wherein the ATSSS rules and the N4 interface rules indicate an amount of traffic to duplicate for one or more Third Generation Partnership Project (3GPP) access paths and one or more non-3GPP access paths.

Aspect 12: A method of wireless communication performed by a network entity, comprising: generating policy and charging control (PCC) rules that indicate that a multi-access (MA) protocol data unit (PDU) session with a redundant steering mode is to be established based at least in part on one or more requirements associated with an application; and transmitting the PCC rules.

Aspect 13: The method of Aspect 12, wherein the network entity is a policy and control function.

Aspect 14: The method of Aspect 12 or 13, further comprising selecting one or more of an uplink duplication factor, a downlink duplication factor, an uplink redundant bitrate, or a downlink redundant bitrate for the MA PDU session, wherein the PCC rules indicate one or more of the uplink duplication factor, the downlink duplication factor, the uplink redundant bitrate, or the downlink redundant bitrate.

Aspect 15: The method of any of Aspects 12-14, further comprising selecting an access path to duplicate, wherein the PCC rules indicate the access path.

Aspect 16: The method of any of Aspects 12-15, wherein transmitting the PCC rules includes transmitting the PCC rules to a session management function.

Aspect 17: The method of any of Aspects 12-16, further comprising receiving the one or more requirements from an application function.

Aspect 18: A method of wireless communication performed by a user equipment (UE), comprising: receiving an indication that a quality of service (QoS) of QoS flows of a single access (SA) protocol data unit (PDU) session can be improved if a multi-access (MA) PDU session with a redundant steering mode is established; and transmitting a request to convert the SA PDU session into the MA PDU session.

Aspect 19: The method of Aspect 18, further comprising receiving access traffic steering, switching, and splitting (ATSSS) rules that indicate, for the MA PDU session, one or more of an indication to use the redundant steering mode, an uplink duplication factor, a downlink duplication factor, an uplink redundant bitrate, a downlink redundant bitrate, or an access path.

Aspect 20: The method of Aspect 19, wherein the ATSSS rules indicate an amount of traffic to duplicate for one or more Third Generation Partnership Project (3GPP) access paths and one or more non-3GPP access paths.

Aspect 21: The method of Aspect 19 or 20, further comprising communicating during the MA PDU session with at least one of the one or more of the uplink duplication factor, the downlink duplication factor, the uplink redundant bitrate, the downlink redundant bitrate, or the access path.

Aspect 22: The method of any of Aspects 18-21, wherein transmitting the request includes transmitting the request based at least in part on one or more of a data transfer requirement, a channel condition, traffic condition, or network coverage.

Aspect 23: A method of wireless communication performed by a network entity, comprising: transmitting an indication that a quality of service (QoS) of QoS flows of a single access (SA) protocol data unit (PDU) session can be improved if a multi-access (MA) PDU session with a redundant steering mode is established; receiving a request to convert the SA PDU session into the MA PDU session; and establishing the MA PDU session.

Aspect 24: The method of Aspect 23, wherein the network entity is a session management function.

Aspect 25: The method of Aspect 23 or 24, further comprising transmitting access traffic steering, switching, and splitting (ATSSS) rules and N4 interface rules that indicate, for the MA PDU session, one or more of an indication to use a redundant steering mode, an uplink duplication factor, a downlink duplication factor, an uplink redundant bitrate, a downlink redundant bitrate, or an access path.

Aspect 26: The method of any of Aspects 23-25, further comprising receiving a data transfer requirement, wherein transmitting the indication includes transmitting the indication based at least in part on one or more of the data transfer requirement, a channel condition, or a traffic condition.

Aspect 27: An apparatus for wireless communication at a device, comprising a processor; memory coupled with the processor; and instructions stored in the memory and executable by the processor to cause the apparatus to perform the method of one or more of Aspects 1-26.

Aspect 28: A device for wireless communication, comprising a memory and one or more processors coupled to the memory, the one or more processors configured to perform the method of one or more of Aspects 1-26.

Aspect 29: An apparatus for wireless communication, comprising at least one means for performing the method of one or more of Aspects 1-26.

Aspect 30: A non-transitory computer-readable medium storing code for wireless communication, the code comprising instructions executable by a processor to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A network entity for wireless communication, comprising:
a memory; and
one or more processors, coupled to the memory, configured to:
receive policy and charging control (PCC) rules that indicate that a multi-access (MA) protocol data unit (PDU) session is to be established with a redundant steering mode;
transmit N4 interface rules that indicate, for the MA PDU session, one or more of an indication to use the redundant steering mode, an uplink duplication factor, a downlink duplication factor, an uplink redundant bitrate, a downlink redundant bitrate, or an access path to duplicate; and
transmit access traffic steering, switching, and splitting (ATSSS) rules that indicate, for the MA PDU session, an indication to use the redundant steering mode, the one or more of the uplink duplication factor, the downlink duplication factor, the uplink redundant bitrate, the downlink redundant bitrate, or the access path.

2. The network entity of claim 1, wherein the network entity is a session management function.

3. The network entity of claim 1, wherein the one or more processors are configured to select the one or more of the uplink duplication factor, the downlink duplication factor, the uplink redundant bitrate, the downlink redundant bitrate, or the access path.

4. The network entity of claim 1, wherein the one or more processors are configured to receive a message that indicates the one or more of the uplink duplication factor, the downlink duplication factor, the uplink redundant bitrate, or the downlink redundant bitrate.

5. The network entity of claim 4, wherein the one or more processors, to receive the message, are configured to receive PCC rules from a policy and control function.

6. The network entity of claim 4, wherein the one or more processors are configured to select the access path.

7. The network entity of claim 4, wherein the message indicates the access path.

8. The network entity of claim 1, wherein the ATSSS rules and the N4 interface rules indicate the redundant steering mode associated with the MA PDU session.

9. The network entity of claim 1, wherein the ATSSS rules and the N4 interface rules indicate an amount of traffic of the access path.

10. The network entity of claim 1, wherein the ATSSS rules and the N4 interface rules indicate the access path.

11. The network entity of claim 1, wherein the ATSSS rules and the N4 interface rules indicate an amount of traffic to duplicate for one or more Third Generation Partnership Project (3GPP) access paths and one or more non-3GPP access paths.

12. A network entity for wireless communication, comprising:
a memory; and
one or more processors, coupled to the memory, configured to:
generate policy and charging control (PCC) rules that indicate that a multi-access (MA) protocol data unit (PDU) session with a redundant steering mode is to be established based at least in part on one or more requirements associated with an application; and
transmit the PCC rules.

13. The network entity of claim 12, wherein the network entity is a policy and control function.

14. The network entity of claim 12, wherein the one or more processors are configured to select one or more of an uplink duplication factor, a downlink duplication factor, an uplink redundant bitrate, or a downlink redundant bitrate for the MA PDU session, and wherein the PCC rules indicate one or more of the uplink duplication factor, the downlink duplication factor, the uplink redundant bitrate, or the downlink redundant bitrate.

15. The network entity of claim 12, wherein the one or more processors are configured to select an access path to duplicate, wherein the PCC rules indicate the access path.

16. The network entity of claim 12, wherein the one or more processors, to transmit the PCC rules, are configured to transmit the PCC rules to a session management function.

17. The network entity of claim 12, wherein the one or more processors are configured to receive the one or more requirements from an application function.

18. A user equipment (UE) for wireless communication, comprising:
a memory; and
one or more processors, coupled to the memory, configured to:
receive an indication that a quality of service (QoS) of QoS flows of a single access (SA) protocol data unit (PDU) session can be improved if a multi-access (MA) PDU session with a redundant steering mode is established; and
transmit a request to convert the SA PDU session into the MA PDU session.

19. The UE of claim 18, wherein the one or more processors are configured to receive access traffic steering, switching, and splitting (ATSSS) rules that indicate, for the MA PDU session, one or more of an indication to use the redundant steering mode, an uplink duplication factor, a downlink duplication factor, an uplink redundant bitrate, a downlink redundant bitrate, or an access path.

20. The UE of claim 19, wherein the ATSSS rules indicate an amount of traffic to duplicate for one or more Third Generation Partnership Project (3GPP) access paths and one or more non-3GPP access paths.

21. The UE of claim 19, wherein the one or more processors are configured to communicate during the MA PDU session with at least one of the one or more of the uplink duplication factor, the downlink duplication factor, the uplink redundant bitrate, the downlink redundant bitrate, or the access path.

22. The UE of claim 18, wherein the one or more processors, to transmit the request, are configured to transmit the request based at least in part on one or more of a data transfer requirement, a channel condition, traffic condition, or network coverage.

23. A network entity for wireless communication, comprising:
a memory; and
one or more processors, coupled to the memory, configured to:
transmit an indication that a quality of service (QoS) of QoS flows of a single access (SA) protocol data unit (PDU) session can be improved if a multi-access (MA) PDU session with a redundant steering mode is established;
receive a request to convert the SA PDU session into the MA PDU session; and
establish the MA PDU session.

24. The network entity of claim 23, wherein the network entity is a session management function.

25. The network entity of claim 23, wherein the one or more processors are configured to transmit access traffic steering, switching, and splitting (ATSSS) rules and N4 interface rules that indicate, for the MA PDU session, one or more of an indication to use a redundant steering mode, an uplink duplication factor, a downlink duplication factor, an uplink redundant bitrate, a downlink redundant bitrate, or an access path.

26. The network entity of claim 23, wherein the one or more processors are configured to receive a data transfer requirement, and wherein the one or more processors, to transmit the indication, are configured to transmit the indication based at least in part on one or more of the data transfer requirement, a channel condition, or a traffic condition.
